(19) United States
(12) Patent Application Publication
(10) Pub. No.: US 2024/0351558 A1
(43) Pub. Date: Oct. 24, 2024

(54) ACTIVATION OF VEHICLE SENSOR CLEANING SYSTEMS

(71) Applicant: GM Cruise Holdings LLC, San Francisco, CA (US)

(72) Inventor: Paul Blackburn, San Francisco, CA (US)

(21) Appl. No.: 18/302,594

(22) Filed: Apr. 18, 2023

(51) Int. Cl. B60S 1/56

(52) U.S. Cl. CPC B60S 1/56; G02B 27/0006

(57) ABSTRACT

Systems and techniques are provided for automatically cleaning sensors based on acoustic data. An example method can include receiving acoustic data collected by one or more acoustic sensors of a vehicle in a scene; based on the acoustic data, determining an acoustic signature associated with sensor contamination; and in response to determining the acoustic signature associated with sensor contamination, triggering one or more sensor cleaning systems to clean one or more additional sensors of the vehicle.

### TECHNICAL FIELD

The present disclosure generally relates to systems and techniques for activating sensor cleaning systems on vehicles. For example, aspects of the disclosure relate to systems and techniques for determining whether to activate vehicle sensor cleaning systems based on acoustic data obtained by acoustic sensors of the vehicle in an environment.

### BACKGROUND

An autonomous vehicle is a motorized vehicle that can navigate without a human driver. An exemplary autonomous vehicle can include various sensors, such as a camera sensor, a light detection and ranging (LIDAR) sensor, and a radio detection and ranging (RADAR) sensor, amongst others. The sensors collect data and measurements that the autonomous vehicle can use for operations such as navigation. The sensors can provide the data and measurements to an internal computing system of the autonomous vehicle, which can use the data and measurements to control a mechanical system of the autonomous vehicle, such as a vehicle propulsion system, a braking system, or a steering system. Typically, the sensors are mounted at fixed locations on the autonomous vehicles.

### BRIEF DESCRIPTION OF THE DRAWINGS

Illustrative examples and aspects of the present application are described in detail below with reference to the following figures:

FIG. 1 illustrates an example system environment that can be used to facilitate autonomous navigation and routing operations, according to some examples of the present disclosure;

FIG. 2 is a diagram illustrating an example environment containing debris that can be collected or accumulated on sensors of a vehicle navigating the environment, according to some examples of the present disclosure;

FIG. 3 is a diagram illustrating an example system for determining an acoustic signature associated with sensor contamination, according to some examples of the present disclosure;

FIG. 4 is a diagram illustrating an example self-cleaning sensor system for an optical sensor, according to some examples of the present disclosure;

FIG. 5 is a diagram illustrating an example implementation of a cleaning system on a sensor platform, according to some examples of the present disclosure;

FIG. 6 is a diagram illustrating another example of a sensor cleaning system that can be implemented by a vehicle, according to some examples of the present disclosure;

FIG. 7 is a diagram illustrating an example process for automatically triggering one or more sensor cleaning systems to clean sensors of a vehicle based on acoustic data, according to some examples of the present disclosure;

FIG. 8 illustrates an example configuration of a neural network 800 that can be used to determine that an acoustic signature is associated with sensor contamination, according to some examples of the present disclosure; and

FIG. 9 illustrates an example processor-based system architecture for implementing certain aspects of the present disclosure.

### DETAILED DESCRIPTION

Certain aspects and examples of this disclosure are provided below. Some of these aspects and examples may be applied independently and some of them may be applied in combination as would be apparent to those of skill in the art. In the following description, for the purposes of explanation, specific details are set forth in order to provide a thorough understanding of aspects and examples of the application. However, it will be apparent that various aspects and examples may be practiced without these specific details. The figures and description are not intended to be restrictive.

The ensuing description provides aspects and examples of the disclosure, and is not intended to limit the scope, applicability, or configuration of the disclosure. Rather, the ensuing description of the aspects and examples of the disclosure will provide those skilled in the art with an enabling description for implementing an example implementation of the disclosure. It should be understood that various changes may be made in the function and arrangement of elements without departing from the scope of the application as set forth in the appended claims.

One aspect of the present technology is the gathering and use of data available from various sources to improve quality and experience. The present disclosure contemplates that in some instances, this gathered data may include personal information. The present disclosure contemplates that the entities involved with such personal information respect and value privacy policies and practices.

As previously explained, autonomous vehicles (AVs) can include various sensors, such as a camera sensor (e.g., an optical camera, a thermal camera, a video camera, etc.), a light detection and ranging (LIDAR) sensor, a radio detection and ranging (RADAR) sensor, an inertial measurement unit (IMU), a time-of-flight (TOF) sensor, an acoustic sensor (e.g., a microphone, ultrasonic sensor, sound navigation and ranging (SONAR), etc.), and/or a global navigation satellite system (GNSS) and/or global positioning system (GPS) receiver, amongst others. The AVs can use the various sensors to collect data and measurements that the AVs can use for AV operations such as perception (e.g., object detection, event detection, tracking, localization, sensor fusion, point cloud processing, image processing, etc.), planning (e.g., route planning, trajectory planning, situation analysis, behavioral and/or action planning, mission planning, etc.), control (e.g., steering, braking, throttling, lateral control, longitudinal control, model predictive control (MPC), proportional-derivative-integral, etc.), prediction (e.g., motion prediction, behavior prediction, etc.), etc. The sensors can provide the data and measurements to an internal computing system of the autonomous vehicle, which can use the data and measurements to control a mechanical system of the autonomous vehicle, such as a vehicle propulsion system, a braking system, and/or a steering system, for example.

In some cases, AVs may operate in environments experiencing a variety of weather, air, and/or road conditions. For example, while operating in an environment, an AV may encounter rain, snow, sleet, fog, mud, ice, dirt, etc. The weather, air, and/or road conditions can cause the sensors (and/or the surfaces of the sensors) used by the AV to navigate to collect and/or accumulate debris from the air and/or ground such as precipitation (e.g., rainwater, ice, snow, sleet, water droplets from fog, etc.), mud, dirt, condensation, plant matter, road matter, other particles, and/or other matter, among others. The sensors of the AV may also encounter other debris from the air and/or ground such as, for example, plant matter, organic matter (e.g., bugs and/or portions thereof, animal shedding, etc.), dirt and/or gravel, sand, oil, and air pollutants, among others. Such debris may collect, deposit, and/or accumulate on the sensors and/or the surface of the sensors, which can obstruct a view, visibility, performance, and/or operation of the sensors. Thus, the debris can negatively impact the performance and/or operation of the sensors which, in turn, can negatively impact the performance and/or operation of the AV. For example, debris on the surface of the sensors, such as dirt, plant matter, organic matter, or precipitation can impede the ability of the sensors to obtain sensor data (e.g., measurements, recordings, image data, etc.) in the environment, degrade the performance of the sensors, increase the noise in the sensor data collected by the sensors, and/or decrease the accuracy of the sensors and/or the sensor data collected by the sensors.

As used herein, the term debris (e.g., debris in the air, debris on the ground, debris on a sensor, debris in the environment, etc.) can include any particles, matter, precipitation (e.g., water, ice, snow, sleet, rain, moisture and/or fog, droplets, etc.), deposits, fluids, pollutants, chemicals, compounds, molecules, and/or solids that, if collected, deposited, and/or accumulated on a sensor and/or surface thereof, can negatively impact a performance (e.g., an accuracy, a stability, a resolution, a quality of collected data and/or associated outputs, etc.) and/or operation of that sensor. Non-limiting examples of debris can include water, snow, ice, dirt, dust, mud, moisture, droplets, fog, grass, plant matter, oil, liquid and/or fluids (e.g., brake fluid, transmission fluid, cleaning fluid, chemicals, etc.), road salt, powder, organic matter (e.g., bugs or portions thereof, shedding from an organism, road kill, etc.), rubbish, waste, litter, sand, gravel, sediments, pollutants, soil, and/or foreign matter (e.g., foreign with respect to a sensor(s) of the vehicle), among others.

Generally, if a surface of an AV sensor becomes partially or fully covered in debris from the environment, a human may be able to manually remove them from the surface of the AV sensor to allow the AV sensor to operate in the environment and/or prevent/minimize any degradation of performance of the AV sensor. However, relying on a human to manually clean the surface of every sensor on an AV to remove any debris on the sensor can be impractical, inconvenient, and/or inefficient. Moreover, in many cases, a human may not be able to clean one or more of the sensors on the AV. For example, a human cannot clean sensors on an exterior of the AV while the AV is moving. Even in cases where a human may be able to clean an AV sensor, there is a risk that, in attempting to manually clean the surface of the AV sensor, the human may unintentionally/accidentally damage the sensor, which can be costly to fix and can impair the operation of the sensor (and the AV that implements the sensor). In some cases, a human may not have the proper tools to adequately clean certain sensors on the AV. Even if a human has the proper tools to adequately clean a sensor of the AV, the human typically may not be able to clean the sensor in real-time and/or while the AV operates. Also, it is otherwise impractical to rely on a human to continuously clean the sensors of an AV as the sensors accumulate or collect debris. In addition, if an AV needs to rely on a human to manually clean any sensors used by the AV to operate, the AV would likely not be able to operate without a human present to clean such sensors.

Systems, apparatuses, processes (also referred to as methods), and computer-readable media (collectively referred to as “systems and techniques”) are described herein for activating sensor cleaning systems on vehicles, such as AVs. For example, the systems and techniques described herein can be used to determine whether (and/or when) to activate one or more vehicle sensor cleaning systems to clean one or more sensors (and/or a surface thereof) of a vehicle. In some examples, the systems and techniques described herein can use acoustic data obtained by an acoustic sensor(s) of a vehicle to determine whether (and/or when) to activate a sensor cleaning system(s) of the vehicle to clean one or more sensors of the vehicle. The system and techniques described herein can use acoustic data from the acoustic sensor(s) to activate the sensor cleaning system(s) to clean any of the sensors of the vehicle, such as sensors on an exterior of the vehicle and/or exposed to an exterior environment of the vehicle. The systems and techniques described herein can activate the sensor cleaning system(s) at any time and/or under any circumstances (e.g., while the AV navigates in an environment or during any other state or operation of the AV).

For example, the systems and techniques described herein can implement one or more acoustic sensors on an AV, such as one or more microphones, and use the one or more acoustic sensors to collect acoustic data in an environment of the AV. The systems and techniques described herein can use the acoustic data to detect certain conditions in the environment that may cause any sensors of the AV, such as external sensors (e.g., sensors on an exterior of the AV and/or exposed to an exterior environment of the AV), to collect or accumulate debris that may impair a performance of such sensors. To illustrate, the systems and techniques described herein may analyze an acoustic signature in the acoustic data that indicates that there may be precipitation (e.g., rain, snow, ice, droplets, water, etc.) in the environment (e.g., in the air and/or the ground) and/or other debris in the environment that may collect and/or accumulate on sensors of the AV (and/or a surface thereof) such as, for example, bugs in the air, air pollution particles, mud and/or dirt on the road, oil, fluids (e.g., brake fluid, transmission fluid, windshield washer fluid, etc.), and/or plant matter.

In some cases, to determine whether the environment around a vehicle is experiencing any conditions that could result in debris collected or accumulated on vehicle sensors, the systems and techniques described herein can search for specific acoustic signatures, specific sounds, specific sound patterns, and/or specific cues and/or features in the acoustic data collected by an acoustic sensor(s) on the vehicle. For example, to determine whether there may be precipitation in the environment (e.g., precipitation in the air and/or ground from weather conditions, precipitation in the air and/or ground from a system such as a fire hydrant, precipitation from a spill or a displacement of a body of water such as a river, etc.) that may cause precipitation to collect and/or accumulate on sensors of the vehicle, the systems and techniques can review the acoustic data collected by a microphone(s) on the vehicle and look for a sound of precipitation (e.g., water or rain, snow, ice, sleet, etc.) impacting (e.g., falling on, hitting, etc.) a surface of the vehicle, the sound of any tires of the vehicle (and/or other vehicles) on a wet surface (e.g., the sound of tires splashing, the sound of tires moving on a wet surface, etc.), the sound of precipitation impacting the ground (e.g., the road, etc.) around/near the vehicle (e.g., water from a fire hydrant splashing and/or hitting the ground, liquid such as oil or water-based fluids being transported splashing and/or hitting the ground, falling precipitation during certain weather conditions, etc.), splashing sounds, and/or other acoustic cues indicative of a likely presence of precipitation in the environment.

As another example, to determine whether there is a threshold likelihood of a presence of other particles in the environment that can be deposited on sensors of the vehicle, the systems and techniques described herein can analyze the acoustic data and look for the sound of certain particles (e.g., bugs, dirt, mud, etc.) impacting a surface of the vehicle, the sound of tires of the vehicle (and/or other vehicles) moving on a surface at least partly covered with certain particles (e.g., bugs, dirt, mud, etc.), the sound of plant matter (e.g., pieces of grass, plants, seeds, etc.), and/or other sounds indicative of a likely presence of other particles in the environment. Upon detecting a sound(s) and/or an acoustic signature(s) that indicates a presence of (and/or a threshold likelihood of a presence of) debris in the environment (e.g., in the air, on the ground, etc.), the systems and techniques described herein can activate one or more sensor cleaning systems to initiate cleaning of one or more sensors (and/or one or more sensor surfaces) of the vehicle.

The systems and techniques described herein can use such acoustic data with or without additional data to determine whether (and/or when) to activate a sensor cleaning system(s) of the vehicle to clean one or more sensors of the vehicle. Accordingly, in some cases, the systems and techniques described herein may only rely on acoustic data obtained by the acoustic sensor(s) of the vehicle to determine whether (and/or when) to activate a sensor cleaning system(s) of the vehicle to clean one or more sensors of the vehicle. However, in other cases, the systems and techniques described herein may use such acoustic data and data from one or more other sources, such as other sensors and/or the Internet, to determine whether (and/or when) to activate a sensor cleaning system(s) of the vehicle to clean one or more sensors of the vehicle. For example, to determine whether (and/or when) to activate a sensor cleaning system(s) of the vehicle to clean one or more sensors of the vehicle, the systems and techniques described herein can use acoustic data collected by the acoustic sensor(s) of the vehicle while the vehicle navigates a scene, as well as data from one or more other sources such as, for example, data from the Internet, weather data from source of weather information, and/or other sensor data collected by one or more sensors of the vehicle while the vehicle navigates the scene. The other sensor data can include, for example and without limitation, image data from one or more camera sensors, point cloud data from one or more light detection and ranging (LIDAR) sensors, a humidity sensor of the vehicle, data from one or more radio detection and ranging (RADAR) sensors, a temperature sensor of the vehicle, and/or other sensor data.

To illustrate, the systems and techniques described herein can use acoustic data collected by one or more acoustic sensors of a vehicle while navigating a scene to determine one or more sounds, sound features, sound characteristics, soundscapes, and/or sound signatures associated with the scene. The systems and techniques described herein can use the one or more sounds, sound features, sound characteristics, soundscapes, and/or sound signatures associated with the scene to determine whether there are (or a likelihood that there are) debris in an environment of the scene (and/or a threshold amount of debris in the scene) and/or whether the acoustic data collected while navigating the scene is associated with sensor contamination.

In some cases, the systems and techniques described herein can additionally use weather information from a weather source (e.g., the Internet, a weather reporting system, etc.) to verify any environment information determined based on the acoustic data and/or verify that an acoustic signature of the acoustic data is associated with sensor contamination. In some examples, the systems and techniques described herein can use weather information from a weather source as another consideration (e.g., in addition to the acoustic data and any other data) in determining whether there are (or a likelihood that there are) debris in an environment of the scene (and/or a threshold amount of debris in the scene) and/or whether an acoustic signature of the acoustic data collected while navigating the scene is associated with sensor contamination. Alternatively or additionally, the systems and techniques described herein can use a humidity sensor and/or a temperature sensor to determine humidity conditions (e.g., precipitation such as rain, fog, etc.) and/or temperature conditions (e.g., freezing conditions, conditions conducive to rain, ice, snow, or sleet, etc.) in the scene and use the humidity conditions and/or the temperature conditions to verify any environment information determined based on the acoustic data and/or as another consideration (e.g., in addition to the acoustic data and any other data) in determining whether there are (or a likelihood that there are) debris in an environment of the scene (and/or a threshold amount of debris in the scene) and/or whether the acoustic signature is associated with sensor contamination.

Alternatively or additionally, the systems and techniques described herein can use an optical sensor, such as a camera sensor and/or a LIDAR sensor, to determine one or more conditions (e.g., precipitation, other debris in the air and/or ground, etc.) in the scene and use the one or more conditions to verify environment information determined based on the acoustic data and/or as another consideration (e.g., in addition to the acoustic data and any other data) in determining whether there are (or a likelihood that there are) debris in an environment of the scene (and/or a threshold amount of debris in the scene) and/or whether the acoustic signature is associated with sensor contamination. For example, the systems and techniques described herein can use an optical sensor to determine one or more characteristics of the scene based on light transmitted and/or received by the optical sensor such as, for example, a reflectivity of one or more surfaces in the scene and/or characteristics of light (e.g., a frequency, an amplitude, a phase shift, a time-of-flight, an amount of reflected light, an amount of refracted light, an amount of scattered light, a signature of transmitted and/or received light, a feature of transmitted and/or received light, etc.) collected by the optical sensor (e.g., ambient light collected by the optical sensor, light reflected from one or more surfaces in the scene and received by the optical sensor, light transmitted by one or more light sources and received by the optical sensor, etc.). The systems and techniques described herein can use the characteristics of light in the scene determined using the optic sensor to determine one or more conditions in the scene and use the one or more conditions to verify environment information determined based on the acoustic data and/or as another consideration (e.g., in addition to the acoustic data and any other data) in determining whether there are (or a likelihood that there are) debris in an environment of the scene (and/or a threshold amount of debris in the scene) and/or whether to trigger one or more sensor cleaning systems.

Alternatively or additionally, the systems and techniques described herein can use a camera sensor to determine one or more conditions in the scene and use the one or more conditions to verify environment information determined based on the acoustic data and/or as another consideration (e.g., in addition to the acoustic data and any other data) in determining whether there are (or a likelihood that there are) debris in an environment of the scene (and/or a threshold amount of debris in the scene) and/or whether to trigger one or more sensor cleaning systems. For example, the systems and techniques described herein can analyze image data captured by the one or more camera sensors and determine whether a performance, quality, and/or noise reflected in the image data is indicative of a clean camera sensor or a camera sensor with a threshold amount of debris.

To illustrate, if the camera sensor has certain amount of debris on a surface of the camera sensor, the image data captured by that camera sensor may reflect a certain degradation of performance and/or a certain amount of noise and/or artifacts in the image data. The systems and techniques described herein can thus use the reflected degradation in performance and/or certain amount of noise and/or artifacts to predict that the camera sensor has a threshold amount of debris. As another example, the systems and techniques described can detect features of the scene depicted in the image data captured by the one or more camera sensors, such as precipitation, a reduced visibility, debris in the air, etc., and use the detected features in the scene to determine that there are debris in the scene. In this way, the systems and techniques described herein can use the acoustic data and the image data (and any other data) to determine one or more conditions in the scene and use the one or more conditions to verify environment information determined based on the acoustic data and/or as another consideration (e.g., in addition to the acoustic data and any other data) in determining whether there are (or a likelihood that there are) debris in an environment of the scene (and/or a threshold amount of debris in the scene) and/or whether to trigger one or more sensor cleaning systems.

The systems and techniques described herein can implement and activate any sensor cleaning system used to clean a surface of a sensor. Non-limiting examples of a sensor cleaning system can include a mechanical wiper(s), a device configured to output compressed air, a device configure to output liquid such as water or cleaning fluid, a device (e.g., a piezoelectric device, a speaker, etc.) configured to emit an electric charge and/or excitations of a specific frequency or frequency range (e.g., a resonant frequency) that can break and/or remove ice and/or snow on a surface of a sensor, and/or a mechanical cleaning device, among others. The systems and techniques described herein can use any system(s) and/or algorithm(s) to analyze acoustic data and determine a trigger in the acoustic data for activating a sensor cleaning system such as, for example, artificial intelligence, a machine learning model, digital signal processing, heuristics, audio signal processing, and/or a sound recognition algorithm, among others.

To illustrate, in some cases, the systems and techniques described herein can use a machine learning algorithm to process acoustic data collected in an environment and recognize sound in (and/or a signature of) the acoustic data corresponds to an environment (and/or recognize associated cues) that contains debris that may collect or accumulate on sensors of the vehicle and/or corresponds to sensor contamination. Based on the recognized sound(s) in (and/or a signature of) the acoustic data, the systems and techniques described herein can activate one or more sensor cleaning systems to clean sensors of the vehicle. As another example, in some cases, the systems and techniques described herein can use an algorithm to process acoustic data collected in an environment and compare a signature of the acoustic data to signatures of acoustic data known to correspond to sensor contamination and/or environments (e.g., that include sounds from such environments and/or were collected in such environments) that contain debris that may collect or accumulate on sensors of the vehicle. Based on a match in the signature of the acoustic data and one or more signatures of acoustic data known to correspond to such sensor contamination and/or environments, the systems and techniques described herein can activate one or more sensor cleaning systems to clean sensors of the vehicle.

In some examples, by relying on acoustic data to determine information about an environment of a vehicle and determine whether to activate one or more sensor cleaning systems, the systems and techniques described herein efficiently make decisions regarding whether to activate any sensor cleaning systems, reduce a compute cost associated with such decisions (e.g., versus relying on other sensor data such as image data), and/or simplify such decision making. For example, the complexity and/or compute cost of an algorithm(s) used to determine whether to activate any sensor cleaning systems based on environment information determined using acoustic data can be significantly lower than the complexity and/or compute costs of an algorithm(s) used to determine whether to activate any sensor cleaning systems based on environment information determined using other sensor data, such as image data (e.g., images, video frames, etc.), LIDAR data, and/or other sensor data. In some cases, the use of acoustic data to determine information about an environment of a vehicle used to determine whether to activate any sensor cleaning systems can be more accurate than using other sensor data, such as image data or any other sensor data.

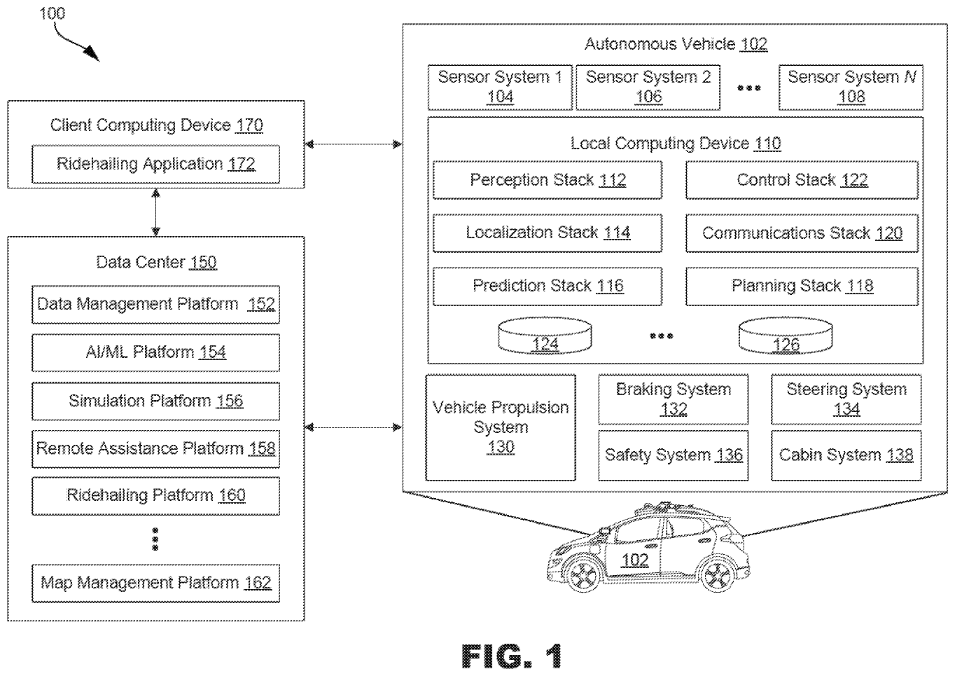

Examples of the systems and techniques described herein are illustrated in FIG. 1 through FIG. 9 and described below.

FIG. 1 is a diagram illustrating an example autonomous vehicle (AV) environment 100, according to some examples of the present disclosure. One of ordinary skill in the art will understand that, for the AV environment 100 and any system discussed in the present disclosure, there can be additional or fewer components in similar or alternative configurations. The illustrations and examples provided in the present disclosure are for conciseness and clarity. Other examples may include different numbers and/or types of elements, but one of ordinary skill the art will appreciate that such variations do not depart from the scope of the present disclosure.

In this example, the AV environment 100 includes an AV 102, a data center 150, and a client computing device 170. The AV 102, the data center 150, and the client computing device 170 can communicate with one another over one or more networks (not shown), such as a public network (e.g., the Internet, an Infrastructure as a Service (IaaS) network, a Platform as a Service (PaaS) network, a Software as a Service (SaaS) network, other Cloud Service Provider (CSP) network, etc.), a private network (e.g., a Local Area Network (LAN), a private cloud, a Virtual Private Network (VPN), etc.), and/or a hybrid network (e.g., a multi-cloud or hybrid cloud network, etc.).

The AV 102 can navigate roadways without a human driver based on sensor signals generated by sensor systems 104, 106, and 108. The sensor systems 104-108 can include one or more types of sensors and can be arranged about the AV 102. For instance, the sensor systems 104-108 can include one or more inertial measurement units (IMUs), camera sensors (e.g., still image camera sensors, video camera sensors, etc.), light sensors (e.g., LIDARs, ambient light sensors, infrared sensors, etc.), RADAR systems, GPS receivers, audio sensors (e.g., microphones, Sound Navigation and Ranging (SONAR) systems, ultrasonic sensors, etc.), engine sensors, speedometers, tachometers, odometers, altimeters, tilt sensors, impact sensors, airbag sensors, time-of-flight (TOF) sensors, seat occupancy sensors, open/closed door sensors, tire pressure sensors, rain sensors, and so forth. For example, the sensor system 104 can include a camera system, the sensor system 106 can include a LIDAR system, and the sensor system 108 can include a RADAR system. Other examples may include any other number and type of sensors.

The AV 102 can include several mechanical systems that can be used to maneuver or operate the AV 102. For instance, the mechanical systems can include a vehicle propulsion system 130, a braking system 132, a steering system 134, a safety system 136, and a cabin system 138, among other systems. The vehicle propulsion system 130 can include an electric motor, an internal combustion engine, or both. The braking system 132 can include an engine brake, brake pads, actuators, and/or any other suitable componentry configured to assist in decelerating the AV 102. The steering system 134 can include suitable componentry configured to control the direction of movement of the AV 102 during navigation. The safety system 136 can include lights and signal indicators, a parking brake, airbags, and so forth. The cabin system 138 can include cabin temperature control systems, in-cabin entertainment systems, and so forth. In some examples, the AV 102 might not include human driver actuators (e.g., steering wheel, handbrake, foot brake pedal, foot accelerator pedal, turn signal lever, window wipers, etc.) for controlling the AV 102. Instead, the cabin system 138 can include one or more client interfaces (e.g., Graphical User Interfaces (GUIs), Voice User Interfaces (VUIs), etc.) for controlling certain aspects of the mechanical systems 130-138.

The AV 102 can include a local computing device 110 that is in communication with the sensor systems 104-108, the mechanical systems 130-138, the data center 150, and/or the client computing device 170, among other systems. The local computing device 110 can include one or more processors and memory, including instructions that can be executed by the one or more processors. The instructions can make up one or more software stacks or components responsible for controlling the AV 102; communicating with the data center 150, the client computing device 170, and other systems; receiving inputs from riders, passengers, and other entities within the AV's environment; logging metrics collected by the sensor systems 104-108; and so forth. In this example, the local computing device 110 includes a perception stack 112, a mapping and localization stack 114, a prediction stack 116, a planning stack 118, a communications stack 120, a control stack 122, an AV operational database 124, and an HD geospatial database 126, among other stacks and systems.

The perception stack 112 can enable the AV 102 to “see” (e.g., via cameras, LIDAR sensors, infrared sensors, etc.), “hear” (e.g., via microphones, ultrasonic sensors, RADAR, etc.), and “feel” (e.g., pressure sensors, force sensors, impact sensors, etc.) its environment using information from the sensor systems 104-108, the mapping and localization stack 114, the HD geospatial database 126, other components of the AV, and/or other data sources (e.g., the data center 150, the client computing device 170, third party data sources, etc.). The perception stack 112 can detect and classify objects and determine their current locations, speeds, directions, and the like. In addition, the perception stack 112 can determine the free space around the AV 102 (e.g., to maintain a safe distance from other objects, change lanes, park the AV, etc.). The perception stack 112 can identify environmental uncertainties, such as where to look for moving objects, flag areas that may be obscured or blocked from view, and so forth. In some examples, an output of the prediction stack can be a bounding area around a perceived object that can be associated with a semantic label that identifies the type of object that is within the bounding area, the kinematic of the object (information about its movement), a tracked path of the object, and a description of the pose of the object (its orientation or heading, etc.).

The mapping and localization stack 114 can determine the AV's position and orientation (pose) using different methods from multiple systems (e.g., GPS, IMUs, cameras, LIDAR, RADAR, ultrasonic sensors, the HD geospatial database 126, etc.). For example, in some cases, the AV 102 can compare sensor data captured in real-time by the sensor systems 104-108 to data in the HD geospatial database 126 to determine its precise (e.g., accurate to the order of a few centimeters or less) position and orientation. The AV 102 can focus its search based on sensor data from one or more first sensor systems (e.g., GPS) by matching sensor data from one or more second sensor systems (e.g., LIDAR). If the mapping and localization information from one system is unavailable, the AV 102 can use mapping and localization information from a redundant system and/or from remote data sources.

The prediction stack 116 can receive information from the localization stack 114 and objects identified by the perception stack 112 and predict a future path for the objects. In some examples, the prediction stack 116 can output several likely paths that an object is predicted to take along with a probability associated with each path. For each predicted path, the prediction stack 116 can also output a range of points along the path corresponding to a predicted location of the object along the path at future time intervals along with an expected error value for each of the points that indicates a probabilistic deviation from that point.

The planning stack 118 can determine how to maneuver or operate the AV 102 safely and efficiently in its environment. For example, the planning stack 118 can receive the location, speed, and direction of the AV 102, geospatial data, data regarding objects sharing the road with the AV 102 (e.g., pedestrians, bicycles, vehicles, ambulances, buses, cable cars, trains, traffic lights, lanes, road markings, etc.) or certain events occurring during a trip (e.g., emergency vehicle blaring a siren, intersections, occluded areas, street closures for construction or street repairs, double-parked cars, etc.), traffic rules and other safety standards or practices for the road, user input, and other relevant data for directing the AV 102 from one point to another and outputs from the perception stack 112, localization stack 114, and prediction stack 116. The planning stack 118 can determine multiple sets of one or more mechanical operations that the AV 102 can perform (e.g., go straight at a specified rate of acceleration, including maintaining the same speed or decelerating; turn on the left blinker, decelerate if the AV is above a threshold range for turning, and turn left; turn on the right blinker, accelerate if the AV is stopped or below the threshold range for turning, and turn right; decelerate until completely stopped and reverse; etc.), and select the best one to meet changing road conditions and events. If something unexpected happens, the planning stack 118 can select from multiple backup plans to carry out. For example, while preparing to change lanes to turn right at an intersection, another vehicle may aggressively cut into the destination lane, making the lane change unsafe. The planning stack 118 could have already determined an alternative plan for such an event. Upon its occurrence, it could help direct the AV 102 to go around the block instead of blocking a current lane while waiting for an opening to change lanes.

The control stack 122 can manage the operation of the vehicle propulsion system 130, the braking system 132, the steering system 134, the safety system 136, and the cabin system 138. The control stack 122 can receive sensor signals from the sensor systems 104-108 as well as communicate with other stacks or components of the local computing device 110 or a remote system (e.g., the data center 150) to effectuate operation of the AV 102. For example, the control stack 122 can implement the final path or actions from the multiple paths or actions provided by the planning stack 118. This can involve turning the routes and decisions from the planning stack 118 into commands for the actuators that control the AV's steering, throttle, brake, and drive unit.

The communications stack 120 can transmit and receive signals between the various stacks and other components of the AV 102 and between the AV 102, the data center 150, the client computing device 170, and other remote systems. The communications stack 120 can enable the local computing device 110 to exchange information remotely over a network, such as through an antenna array or interface that can provide a metropolitan WIFI network connection, a mobile or cellular network connection (e.g., Third Generation (3G), Fourth Generation (4G), Long-Term Evolution (LTE), 5th Generation (5G), etc.), and/or other wireless network connection (e.g., License Assisted Access (LAA), Citizens Broadband Radio Service (CBRS), MULTEFIRE, etc.). The communications stack 120 can also facilitate the local exchange of information, such as through a wired connection (e.g., a user's mobile computing device docked in an in-car docking station or connected via Universal Serial Bus (USB), etc.) or a local wireless connection (e.g., Wireless Local Area Network (WLAN), Bluetooth®, infrared, etc.).

The HD geospatial database 126 can store HD maps and related data of the streets upon which the AV 102 travels. In some examples, the HD maps and related data can include multiple layers, such as an areas layer, a lanes and boundaries layer, an intersections layer, a traffic controls layer, and so forth. The areas layer can include geospatial information indicating geographic areas that are drivable (e.g., roads, parking areas, shoulders, etc.) or not drivable (e.g., medians, sidewalks, buildings, etc.), drivable areas that constitute links or connections (e.g., drivable areas that form the same road) versus intersections (e.g., drivable areas where two or more roads intersect), and so on. The lanes and boundaries layer can include geospatial information of road lanes (e.g., lane centerline, lane boundaries, type of lane boundaries, etc.) and related attributes (e.g., direction of travel, speed limit, lane type, etc.). The lanes and boundaries layer can also include three-dimensional (3D) attributes related to lanes (e.g., slope, elevation, curvature, etc.). The intersections layer can include geospatial information of intersections (e.g., crosswalks, stop lines, turning lane centerlines and/or boundaries, etc.) and related attributes (e.g., permissive, protected/permissive, or protected only left turn lanes; legal or illegal u-turn lanes; permissive or protected only right turn lanes; etc.). The traffic controls lane can include geospatial information of traffic signal lights, traffic signs, and other road objects and related attributes.

The AV operational database 124 can store raw AV data generated by the sensor systems 104-108, stacks 112-122, and other components of the AV 102 and/or data received by the AV 102 from remote systems (e.g., the data center 150, the client computing device 170, etc.). In some examples, the raw AV data can include HD LIDAR point cloud data, image data, RADAR data, GPS data, and other sensor data that the data center 150 can use for creating or updating AV geospatial data or for creating simulations of situations encountered by AV 102 for future testing or training of various machine learning algorithms that are incorporated in the local computing device 110.

The data center 150 can include a private cloud (e.g., an enterprise network, a co-location provider network, etc.), a public cloud (e.g., an Infrastructure as a Service (IaaS) network, a Platform as a Service (PaaS) network, a Software as a Service (SaaS) network, or other Cloud Service Provider (CSP) network), a hybrid cloud, a multi-cloud, and/or any other network. The data center 150 can include one or more computing devices remote to the local computing device 110 for managing a fleet of AVs and AV-related services. For example, in addition to managing the AV 102, the data center 150 may also support a ridesharing service, a delivery service, a remote/roadside assistance service, street services (e.g., street mapping, street patrol, street cleaning, street metering, parking reservation, etc.), and the like.

The data center 150 can send and receive various signals to and from the AV 102 and the client computing device 170. These signals can include sensor data captured by the sensor systems 104-108, roadside assistance requests, software updates, ridesharing pick-up and drop-off instructions, and so forth. In this example, the data center 150 includes a data management platform 152, an Artificial Intelligence/Machine Learning (AI/ML) platform 154, a simulation platform 156, a remote assistance platform 158, and a ridehailing platform 160, and a map management platform 162, among other systems.

The data management platform 152 can be a “big data” system capable of receiving and transmitting data at high velocities (e.g., near real-time or real-time), processing a large variety of data and storing large volumes of data (e.g., terabytes, petabytes, or more of data). The varieties of data can include data having different structures (e.g., structured, semi-structured, unstructured, etc.), data of different types (e.g., sensor data, mechanical system data, ridesharing service, map data, audio, video, etc.), data associated with different types of data stores (e.g., relational databases, key-value stores, document databases, graph databases, column-family databases, data analytic stores, search engine databases, time series databases, object stores, file systems, etc.), data originating from different sources (e.g., AVs, enterprise systems, social networks, etc.), data having different rates of change (e.g., batch, streaming, etc.), and/or data having other characteristics. The various platforms and systems of the data center 150 can access data stored by the data management platform 152 to provide their respective services.

The AI/ML platform 154 can provide the infrastructure for training and evaluating machine learning algorithms for operating the AV 102, the simulation platform 156, the remote assistance platform 158, the ridehailing platform 160, the map management platform 162, and other platforms and systems. Using the AI/ML platform 154, data scientists can prepare data sets from the data management platform 152; select, design, and train machine learning models; evaluate, refine, and deploy the models; maintain, monitor, and retrain the models; and so on.

The simulation platform 156 can enable testing and validation of the algorithms, machine learning models, neural networks, and other development efforts for the AV 102, the remote assistance platform 158, the ridehailing platform 160, the map management platform 162, and other platforms and systems. The simulation platform 156 can replicate a variety of driving environments and/or reproduce real-world scenarios from data captured by the AV 102, including rendering geospatial information and road infrastructure (e.g., streets, lanes, crosswalks, traffic lights, stop signs, etc.) obtained from the map management platform 162 and/or a cartography platform; modeling the behavior of other vehicles, bicycles, pedestrians, and other dynamic elements; simulating inclement weather conditions, different traffic scenarios; and so on.

The remote assistance platform 158 can generate and transmit instructions regarding the operation of the AV 102. For example, in response to an output of the AI/ML platform 154 or other system of the data center 150, the remote assistance platform 158 can prepare instructions for one or more stacks or other components of the AV 102.

The ridehailing platform 160 can interact with a customer of a ridesharing service via a ridehailing application 172 executing on the client computing device 170. The client computing device 170 can be any type of computing system such as, for example and without limitation, a server, desktop computer, laptop computer, tablet computer, smartphone, smart wearable device (e.g., smartwatch, smart eyeglasses or other Head-Mounted Display (HMD), smart ear pods, or other smart in-ear, on-ear, or over-ear device, etc.), gaming system, or any other computing device for accessing the ridehailing application 172. In some cases, the client computing device 170 can be a customer's mobile computing device or a computing device integrated with the AV 102 (e.g., the local computing device 110). The ridehailing platform 160 can receive requests to pick up or drop off from the ridehailing application 172 and dispatch the AV 102 for the trip.

Map management platform 162 can provide a set of tools for the manipulation and management of geographic and spatial (geospatial) and related attribute data. The data management platform 152 can receive LIDAR point cloud data, image data (e.g., still image, video, etc.), RADAR data, GPS data, and other sensor data (e.g., raw data) from one or more AVs 102, Unmanned Aerial Vehicles (UAVs), satellites, third-party mapping services, and other sources of geospatially referenced data. The raw data can be processed, and map management platform 162 can render base representations (e.g., tiles (2D), bounding volumes (3D), etc.) of the AV geospatial data to enable users to view, query, label, edit, and otherwise interact with the data. Map management platform 162 can manage workflows and tasks for operating on the AV geospatial data. Map management platform 162 can control access to the AV geospatial data, including granting or limiting access to the AV geospatial data based on user-based, role-based, group-based, task-based, and other attribute-based access control mechanisms. Map management platform 162 can provide version control for the AV geospatial data, such as to track specific changes that (human or machine) map editors have made to the data and to revert changes when necessary. Map management platform 162 can administer release management of the AV geospatial data, including distributing suitable iterations of the data to different users, computing devices, AVs, and other consumers of HD maps. Map management platform 162 can provide analytics regarding the AV geospatial data and related data, such as to generate insights relating to the throughput and quality of mapping tasks.

In some examples, the map viewing services of map management platform 162 can be modularized and deployed as part of one or more of the platforms and systems of the data center 150. For example, the AI/ML platform 154 may incorporate the map viewing services for visualizing the effectiveness of various object detection or object classification models, the simulation platform 156 may incorporate the map viewing services for recreating and visualizing certain driving scenarios, the remote assistance platform 158 may incorporate the map viewing services for replaying traffic incidents to facilitate and coordinate aid, the ridehailing platform 160 may incorporate the map viewing services into the client application 172 to enable passengers to view the AV 102 in transit to a pick-up or drop-off location, and so on.

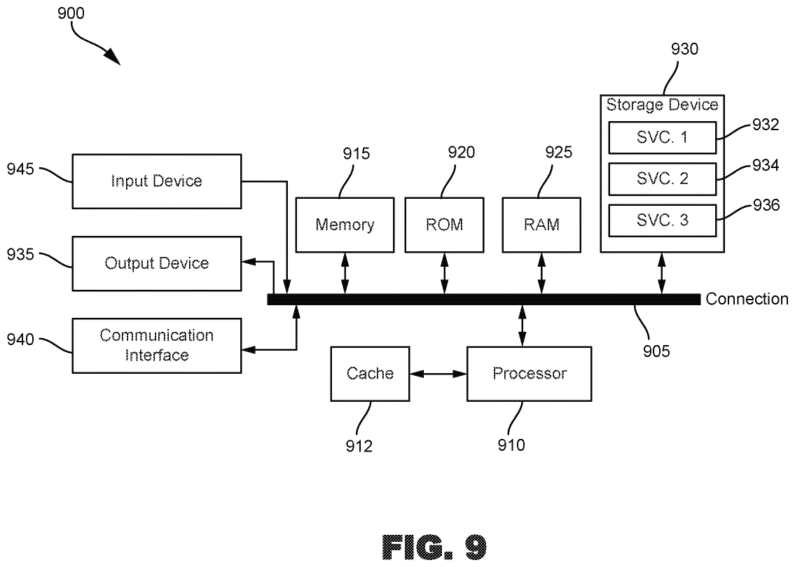

While the AV 102, the local computing device 110, and the autonomous vehicle environment 100 are shown to include certain systems and components, one of ordinary skill will appreciate that the AV 102, the local computing device 110, and/or the autonomous vehicle environment 100 can include more or fewer systems and/or components than those shown in FIG. 1. For example, the AV 102 can include other services than those shown in FIG. 1 and the local computing device 110 can, in some instances, include one or more memory devices (e.g., RAM, ROM, cache, and/or the like), one or more network interfaces (e.g., wired and/or wireless communications interfaces and the like), and/or other hardware or processing devices that are not shown in FIG. 1. An illustrative example of a computing device and hardware components that can be implemented with the local computing device 110 is described below with respect to FIG. 9.

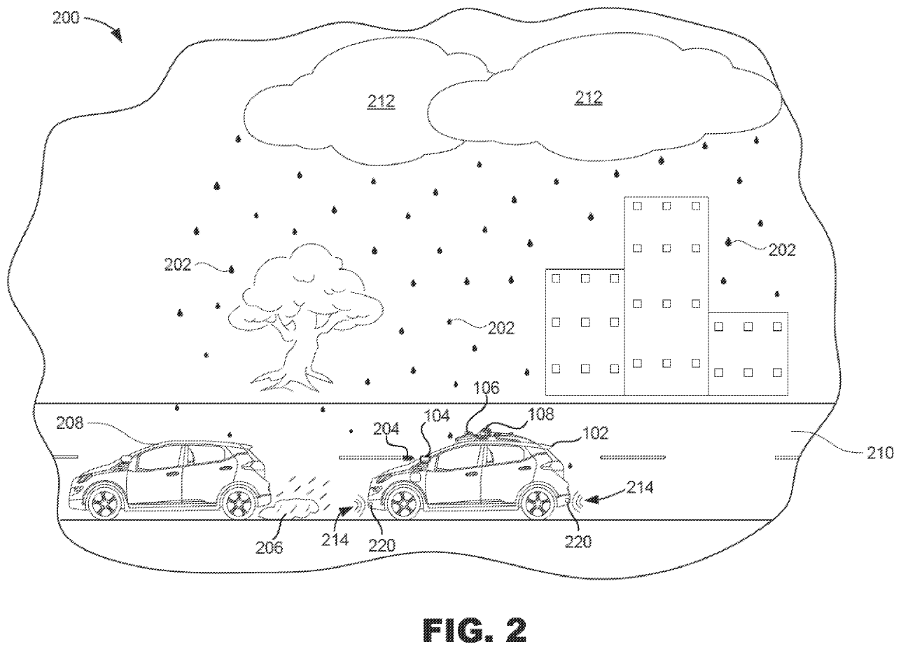

FIG. 2 is a diagram illustrating an example environment 200 containing debris that can be collected or accumulated on sensors of a vehicle navigating the environment 200. As further explained herein, the AV 102 can use acoustic sensors 220, such as microphones, to collect acoustic data from the environment 200, which the AV 102 (e.g., the local computing device 110 of the AV 102) can use to detect the debris in the environment 200, determine that an acoustic signature of the acoustic data is associated with sensor contamination (e.g., is indicative of sensor contamination and/or a threshold likelihood of sensor contamination), and/or determine a likelihood of a presence of debris in the environment 200. In response to detecting the debris, the acoustic signature is associated with sensor contamination, and/or the likelihood of a presence of debris in the environment 200, the AV 102 can determine whether to activate one or more cleaning systems to clean any of the sensor systems 104-108 of the AV 102 and/or otherwise remove debris deposited, collected, and/or accumulated on any of the sensor systems 104-108 of the AV 102.

The debris can include debris in the air, the ground, and/or in the environment that can be deposited, collected, and/or accumulated on sensors of a vehicle in the environment 200, such as AV 102. As previously noted, the debris as used herein can include any particles, matter, precipitation (e.g., water, ice, snow, sleet, rain, moisture and/or fog, droplets, etc.), deposits, fluids, pollutants, chemicals, compounds, molecules, and/or solids that, if collected, deposited, and/or accumulated on a sensor and/or surface thereof, can negatively impact a performance (e.g., an accuracy, a stability, a resolution, a quality of collected data and/or associated outputs, etc.) and/or operation of that sensor. For example and without limitation, the debris can include water, snow, ice, dirt, dust, mud, moisture, droplets, fog, grass, plant matter, oil, liquid and/or fluids (e.g., brake fluid, transmission fluid, cleaning fluid, chemicals, etc.), road salt, powder, organic matter (e.g., bugs or portions thereof, shedding from an organism, road kill, etc.), rubbish, waste, litter, sand, gravel, sediments, pollutants, soil, and/or foreign matter (e.g., foreign with respect to a sensor(s) of the vehicle), among others.

The debris can be deposited, collected, and/or accumulated on any sensors of the AV 102, such as any sensors mounted and/or located on an exterior of the AV 102 and/or exposed to the environment 200 of the AV 102. For example, the debris can be deposited, collected, and/or accumulated on sensor system 104, sensor system 106, and/or sensor system 108 on the AV 102. The debris can be deposited, collected, and/or accumulated on sensors of the AV 102 (e.g., sensor systems 104, 106, and/or 108) due to the presence of the AV 102 in the environment 200, such the AV 102 navigating in the environment 200, the AV 102 stopped in the environment 200, the AV 102 parked in the environment 200, etc.

For example, debris in the air can fall on sensor systems 104-108 of the AV 102 and/or otherwise be deposited on sensor systems 104-108 of the AV 102 while the AV 102 drives and/or is stopped in the environment 200. To illustrate, debris carried in the air can be deposited on the sensor systems 104-108 as the debris fall from the clouds 212 in the environment 200 (e.g., driven by gravity) and/or are otherwise driven or propelled by a force acting on the air in the environment 200 such as wind, pockets of other air, other moving objects in the environment 200, etc. In another example, debris on the ground 210 (e.g., the road/street) can be propelled from the ground 210 to the air and to the sensor systems 104-108 of the AV 102 by a force on the ground 210 and/or debris, such as a force from tires of the AV 102 and/or other transportation systems (e.g., other vehicles, bicycles, motorcycles, trains, buses, etc.) making contact with the ground 210 and/or debris on the ground 210 to push/move the AV 102 and/or other transportation systems (e.g., vehicle 208, etc.) as they navigate the environment 200 while the AV 102 is present in the environment 200.

In the illustrative example of FIG. 2, the debris includes precipitation 202 in the air (e.g., precipitation in fog and/or falling from the clouds 212), liquid droplets accumulated in a puddle 206 on the ground 210 (e.g., water, snow, slushy, oil, brake fluid, washer fluid, transmission fluid, chemicals, etc.), and matter 204 in the air. The precipitation 200 can include rain, snow, sleet or ice, water droplets (e.g., droplets from fog and/or condensation, etc.), precipitation in vapor (e.g., from evaporation, etc.), mixed states of matter (e.g., mixed states of water such as mixed rain and snow or ice/sleet, mixed snow and ice/sleet, rain and fog, etc.), and/or any other precipitation in the environment 200. For example, the precipitation 200 can include rain, snow, sleet or ice, water droplets, precipitation in vapor, and/or mixed states of matter in the air (e.g., carried in the air, falling from the clouds 212, propelled from the ground 210 and/or any other surface in the environment 200, etc.) and/or falling to the ground 210. The matter 204 in this example includes bugs. However, in other examples, the matter 204 can include other types of debris such as dirt/dust, mud, gravel, road salt, litter, pollutants, etc., falling in the air and/or pushed to the air from the ground 210 by a force acting on the ground 210 and/or debris on the ground 210.

The precipitation 202 can be deposited on the sensor systems 104-108 of the AV 102 as the precipitation 202 falls from the clouds 212, is carried by air in the environment 200, and/or is propelled from a surface (e.g., from the ground 210, from a surface of an object, etc.) to the air in the environment 200 by one or more forces. The one or more forces can include, for example, a force created by a movement of air (e.g., wind, drag, thrust, airflow, etc.) and/or created or acted on by one or more objects in the environment 200 (e.g., on the ground 210, in the air, etc.), such as the vehicle 208 navigating in the environment 200. In some cases, the precipitation 202 and/or other precipitation sources can deposit liquid or droplets on the ground 210 to form a puddle 206. Moreover, liquid or droplets on the ground 210, the puddle 206, and/or on another surface (e.g., on the vehicle 208, the AV 102, etc.) can be deposited on the sensor systems 104-108 by one or more forces acting on the liquid and/or droplets such as a force of a moving object (e.g., a tire, the vehicle 208, the AV 102, a bicycle, etc.), a force from an organism (e.g., a pedestrian, a dog, a horse, etc.), and/or a force from a movement of air (e.g., wind, drag, thrust, airflow, etc.) generated by one or more objects in the environment 200 and/or environmental conditions (e.g., pressure, temperature, etc.).

For example, debris (e.g., liquid, droplets, mud, slush, etc.) from the puddle 206 can be propelled from the puddle 206 into the air and onto the sensor systems 104-108 by a force created by the movement of air (e.g., wind, etc.) and/or other forces such as the force of a tire(s) of a moving object, such as the vehicle 208 and/or the AV 102. To illustrate, debris (e.g., liquid/droplets, mud, slush, etc.) from the puddle 206 can be propelled from the ground 210 to the air and onto the sensor systems 104-108 as the tires of the vehicle 208 and/or the AV 102 navigate over the puddle 206. In this example, the force created by the rotation and/or friction of the tires of the vehicle 208 and/or the AV 102 on the puddle 206 can cause the particles in the puddle 206 to be propelled from the puddle 206 (e.g., splashed into the air) and deposited onto the sensor systems 104-108 of the AV 102.

Matter 204 in the environment 200 (e.g., in the air, etc.) can also be deposited, collected, and/or accumulated on the sensor systems 104-108 of the AV 102. For example, the flow of air in the environment 200 (e.g., wind) can carry and/or deposit the matter 204 onto the sensor systems 104-108 of the AV 102. In some examples, the matter 204 can additionally or alternatively propel itself in the environment 200 and be deposited, collected, and/or accumulated on the sensor systems 104-108 as the matter 204 and the sensor systems 104-108 collide (e.g., due to motion of the AV 102 and/or the matter 204). To illustrate, in FIG. 2, the matter 204 represents a bug capable of moving (e.g., flying, sliding, walking, etc.). The bug can collide with and be deposited on the sensor systems 104-108 as the bug flies in the air and/or moves in the environment 200. In some cases, the bug can additionally or alternatively be propelled into the air and onto the sensor systems 104-108 by another force such as a movement of air, a force on the bug created by another object, and/or a force on the bug created upon the bug colliding with another object, such as the vehicle 208 ahead of the AV 102.

As previously noted, the AV 102 can include acoustic sensors 220 (e.g., microphones) that the AV 102 can use to collect acoustic data in the environment 200. In FIG. 2, the AV 102 includes two acoustic sensors. However, in other examples, the AV 102 can include more or less acoustic sensors than shown in FIG. 2. For example, in other cases, the AV 102 can include one acoustic sensor or more than two acoustic sensors. The acoustic sensors 220 can be placed anywhere on the AV 102 that would allow the acoustic sensors 220 to detect sound waves 214 in the environment 200. For example, the acoustic sensors 220 can be placed or mounted on a body and/or exterior of the AV 102.

The acoustic sensors 220 can detect sound waves 214 in the environment, which the AV 102 can use to detect an acoustic signature associated with sensor contamination. In some examples, the acoustic signature associated with sensor contamination can include an acoustic signature that indicates and/or corresponds to (e.g., matches a predetermined acoustic signature associated with) a presence of debris (e.g., precipitation 202, matter 204, etc.) in the environment 200 (and/or a threshold amount of debris in the environment 200), which may be deposited on the sensor systems 104-108 of the AV 102, and/or a likelihood of sensor contamination (e.g., a likelihood of debris being deposited on the sensor systems 104-108 of the AV 102). In some cases, the AV 102 can use the sound waves 214 to detect debris in the environment 200, an acoustic signature indicative of a presence of debris in the environment 200, and/or a likelihood of a presence of debris in the environment 200. For example, the acoustic sensors 220 can detect (e.g., collect, capture, measure, analyze, sense, etc.) sound waves 214 in the environment 200, and the AV 102 (e.g., a local computing device 110 of the AV 102) can determine, based on the sound waves 214 in the environment 200, an acoustic signature associated with sensor contamination, a presence (and/or a likelihood of a presence) of debris in the environment 200, and/or sound indicative of a presence of debris in the environment 200 and/or sensor contamination.

In some examples, the sound waves 214 can be caused and/or generated by precipitation 202 falling on any surfaces in the environment 200 (e.g., on a surface of the AV 102, a surface of the vehicle 208, a surface of the ground 210, a surface of the puddle 206, and/or a surface of other items in the environment 200 such as buildings, trees, structures, etc.), debris in the air (e.g., matter 204 in the air, etc.), certain sounds in the environment 200 (e.g., thunder, wind, windshield wipers moving, shoveling of snow/ice, inclement weather vehicles, etc.), and/or created by an impact between debris (e.g., precipitation 202, matter 204, liquid from the puddle 206, etc.) in the environment 200 and any surface in the environment 200 (e.g., a surface on the ground 210, a surface of the puddle 206, a surface of the AV 102, a surface of the vehicle 208, a surface of any other object and/or structure, etc.). For example, the sound waves 214 sensed by the acoustic sensors 200 can additionally or alternatively be caused and/or created by a rotation of tires (e.g., tires of the AV 102, tires of the vehicle 208, and/or any other tires in the environment 200) on a wet surface of the ground 210 (e.g., on the puddle 206, on a portion(s) of the ground 210 containing precipitation and/or covered by precipitation, etc.), an impact of debris on one or more surfaces (e.g., a surface of the ground 210, a surface of the puddle 206, a surface of the AV 102, a surface of the vehicle 208, etc.), movement of windshield wipers of one or more vehicles, a sound generated by an inclement weather vehicle (e.g., a vehicle dropping road salt, etc.), a sound of a shovel removing precipitation (e.g., ice, snow, slush, water, etc.), a sound of vehicle brakes when wet, a sound of a vehicle (e.g., tires of the vehicle) moving or sliding on precipitation on the ground 210, etc.

In some examples, the acoustic sensors 220 can detect the sound waves 214 and the AV 102 can determine that the sound waves 214 correspond to (e.g., are created/generated by, are likely to result from, are manifested in conditions including, etc.) and/or an acoustic signature of the sound waves 214 corresponds to a splashing sound, a sound of tires moving or sliding on a surface with precipitation (e.g., with water, ice, slush, snow, etc.), a sound of windshield wipers on a vehicle, a sound of a shovel moving or removing precipitation (e.g., ice, snow, slush, water, etc.), a sound of a tool used to break and/or remove ice, a sound of thunder in the environment 200, a sound of water flowing in the environment 200, a sound of wind, and/or a sound of debris (e.g., precipitation 202, particles from the puddle 206, matter 204, and/or other debris) falling on and/or colliding with a surface(s) in the environment 200, such as a surface on the ground 210, the puddle 206, the vehicle 208, the AV 102, a tree or plant, and/or a structure in the environment 200 (e.g., a house, a roof, a bus stop shelter, etc.). The AV 102 can then determine that the sound waves 214 and/or an acoustic signature of the sound waves 214 is/are indicative of debris in the environment 200, sensor contamination, and/or a probability of a presence of debris in the environment 200 and/or one or more sensors of the AV 102.

For example, the acoustic sensors 220 can detect the sound waves 214 and the AV 102 can determine that the sound waves 214 (and/or an associated acoustic signature) include and/or correspond to sound generated by an impact between debris in the environment 200 and a surface(s) in the environment 200, such as a surface of the ground 210, a surface of the puddle 206, a surface of the AV 102, a surface of the vehicle 208, and/or any other surface. Based on the determination that the sound waves 214 (and/or an associated acoustic signature) include and/or correspond to sound generated by an impact between the debris in the environment 200 and a surface(s) in the environment 200, the AV 102 can determine that the environment 200 includes precipitation, that the sound waves 214 (and/or an associated acoustic signature) are associated with sensor contamination (e.g., are indicative of sensor contamination and/or a likelihood of sensor contamination), and/or that a likelihood of a presence of debris in the environment 200 exceed a threshold. In other examples, the AV 102 can determine that the sound waves 214 (and/or an associated acoustic signature) include and/or correspond to other cues associated with an environment with precipitation such as, for example, a sound of thunder, a sound of tires moving on a surface with debris such as precipitation or road salt, a sound of windshield wipers moving on one or more vehicles, a sound of a shovel moving precipitation, a sound of snow tires or tires with chains or other traction elements, and/or a sound of a type of vehicle such as a vehicle depositing road salt.

In some examples, the AV 102 (e.g., the local computing device 110 of the AV 102) can analyze the sound waves 214 detected by the acoustic sensors 220 and determine an acoustic signature of the sound waves 214. The acoustic signature can include one or more features (e.g., one or more sounds, wavelengths, amplitudes, frequencies, time periods, velocities, sound vibrations, patterns, noise ratios, noise levels, sound lengths, audio signal segments, acoustic energy and/or energy sequence, etc.) and/or signal characteristics associated with the sound waves 214. In some cases, the AV 102 can then determine that the acoustic signature (e.g., one or more features, and/or signal characteristics associated with the sound waves 214) matches one or more acoustic signatures of an environment that includes debris (e.g., precipitation 202, puddle 206, matter 204, etc.) and/or an environment that can cause (and/or has caused) sensor contamination. For example, the AV 102 can compare one or more features and/or signal characteristics associated with an acoustic signature of the sound waves 214 with one or more features and/or signal characteristics associated with one or more acoustic signatures of sound waves known to correspond to (and/or collected in) environments with debris, sounds created by debris in the environment, and/or sounds created in environments with debris and/or resulting in sensor contamination. As another example, the AV 102 can compare the sound waves 214 with other sound waves known to correspond to environments with debris, sounds created by debris in the environment, and/or sounds created in environments with debris.

In some cases, the AV 102 can determine that the acoustic signature of the sound waves 214 corresponds to and/or is indicative of sounds created by debris in the environment, sensor contamination, and/or a presence of debris in the environment. For example, based an acoustic signature of the sound waves 214, the AV 102 can determine that the sound waves 214 include and/or correspond to thunder, sounds of windshield wipers, sounds of snow tires or tires with chains or other traction elements, sounds of an inclement weather vehicle, sounds of road salt being deposited on the ground 210, sounds of shovels removing precipitation (e.g., ice, snow, slush, etc.), splashing sounds, and/or sounds of debris (e.g., precipitation 202, particles from the puddle 206, matter 204, and/or other debris) falling on and/or colliding with a surface(s) in the environment 200, such as a surface on the ground 210, the puddle 206, the vehicle 208, the AV 102, a tree or plant, and/or a structure in the environment 200 (e.g., a house, a roof, a bus stop shelter, etc.). To illustrate, based on the acoustic signature of the sound waves 214, the AV 102 can classify and/or recognize the sound waves 214 (and/or a sound(s) associated with the sound waves 214) as a particular sound such as a splashing sound, a thunder sound, and/or a sound of debris falling on and/or colliding with one or more surfaces in the environment 200.

In some examples, the AV 102 can implement a classifier (e.g., a neural network classifier model) and/or sound recognition algorithm (e.g., a machine learning-based algorithm, a heuristics-based algorithm, etc.) to recognize the sound waves 214 (and/or an associated acoustic signature) as corresponding to and/or including a sound of debris in the environment 200. The AV 102 can determine whether to activate one or more cleaning systems to clean any of the sensor systems 104-108 and/or remove particles from any of the sensor systems 104-108 based on a classification/recognition result generated from the sound waves 214 (and/or an associated acoustic signature) and/or a determination that the sound waves 214 (and/or an associated acoustic signature) correspond to and/or are indicative of a presence of debris in the environment 200 and/or sensor contamination.

In some cases, the AV 102 can use the acoustic sensors 220 to perform acoustic localization of certain sounds, such as sounds from the precipitation 202, the puddle 206, the matter 204, and/or any other debris. For example, the AV 102 can perform acoustic triangulation using data from the acoustic sensors 220 to localize certain sounds. By localizing certain sounds, the AV 102 can determine whether the sounds correspond to certain types of contamination in the environment (e.g., a puddle versus a pond, a splash versus an ocean, etc.), whether the sounds indicate a presence of certain debris in a path of the AV 102 (e.g., on the road or in the air along a path of the AV 102 versus on a sidewalk or a yard) which may collect on sensors of the AV 102 (and thus may trigger one or more sensor cleaning systems), and/or whether the sounds are indicative of certain environmental conditions (e.g., raining versus watering of plants, etc.) that may trigger one or more sensor cleaning systems to clean one or more sensors of the AV 102.

In some examples, the AV 102 can use data from other sources, in addition to the sound waves 214, to determine whether the AV 102 should activate one or more sensor cleaning systems to clean one or more sensors (e.g., sensor system 104, sensor system 106, sensor system 108) of the AV 102. For example, in some cases, the AV 102 can use the information about the environment determined based on the sound waves 214, as previously described, in addition to weather data from a source such as a weather reporting service or the Internet, a humidity of the environment 200 measured by a humidity sensor of the AV 102, a temperature of the environment 200 measured by a temperature sensor of the AV 102, characteristics of the environment 200 determined based on light transmitted and/or received by an optical sensor(s) of the AV 102, characteristics of the environment 200 detected based on image data captured by one or more camera sensors of the AV 102, and/or other data.

To illustrate, the humidity of the environment 200 can supplement the acoustic data about the environment 200 (e.g., sound waves 214) because it can indicate whether there is a threshold amount of humidity and/or precipitation in the environment 200 (e.g., rain, droplets from fog, drizzling, snowing, etc.), which can be used to determine whether there are debris (e.g., precipitation, mud, etc.) in the environment 200 and/or a threshold amount of debris in the environment 200 (e.g., a certain amount of precipitation that can collect on a sensor and degrade a performance of the sensor by a threshold amount). The temperature of the environment 200 can supplement the acoustic data (and, in some cases, the humidity data) about the environment 200 because it can indicate whether the temperature in the environment 200 is below freezing, which can indicate that humidity/precipitation in the environment 200 may be in the form of ice, above freezing, which can indicate that humidity/precipitation in the environment 200 is in the form of rain/water, or within a range above and below a freezing temperature, which can indicate that humidity/precipitation in the environment 200 may be in the form of ice, rain/water, snow, sleet, slush, and/or mixed precipitation (e.g., mixed rain, snow, ice, and/or sleet).

As another example, data collected by an optical sensor, such as a camera sensor and/or a LIDAR sensor, can supplement the acoustic data because the data from the optical sensor can be used to determine one or more characteristics of the environment 200, such as a presence and/or amount of debris in the environment 200, based on light transmitted and/or received by the optical sensor. To illustrate, the data collected by the optical sensor can be used to determine the one or more characteristics of the environment 200 based on a light reflectivity of one or more surfaces in the environment 200 and/or one or more characteristics of light (e.g., a frequency, an amplitude, a phase shift, a time-of-flight, an amount of reflected light, an amount of refracted light, an amount of scattered light, a signature of transmitted and/or received light, a feature of transmitted and/or received light, etc.) collected by the optical sensor (e.g., ambient light collected by the optical sensor, light reflected from one or more surfaces in the scene and received by the optical sensor, light transmitted by one or more light sources and received by the optical sensor, etc.). The AV 102 can use the characteristics of light in the environment 200 determined using the optic sensor to determine one or more conditions in the scene and use the one or more conditions to verify the environment information determined based on the acoustic data (e.g., sound waves 214) and/or as another consideration (e.g., in addition to the acoustic data and any other data) to determine a presence and/or amount of debris in the environment 200 (and/or a likelihood of sensor contamination).

In some cases, the AV 102 can alternatively or additionally supplement the acoustic data (e.g., sound waves 214) with image data from a camera sensor(s) of the AV 102 to verify the environment information determined based on the acoustic data and/or as another consideration (e.g., in addition to the acoustic data and any other data) in determining whether there is (or a likelihood that there is) debris in the environment 200 (and/or a threshold amount of debris) and/or whether there is sensor contamination (or a likelihood thereof). For example, the AV 102 can use the image data from the camera sensor(s) to determine one or more conditions in the scene and use the one or more conditions to verify the environment information determined based on the acoustic data and/or as another consideration in determining whether there is (or a likelihood that there is) debris in the environment 200 and/or whether there is sensor contamination (and/or a likelihood thereof). To illustrate, the AV 102 can analyze the image data captured by the camera sensor to detect features of the environment 200 depicted in the image data such as precipitation, a reduced visibility, debris in the air, etc., and use the detected features in the environment 200 to determine that there are debris in the environment 200 (e.g., to supplement the acoustic data and/or verify the acoustic data) and/or sensor contamination.

In some cases, the AV 102 can supplement the acoustic data (e.g., the sound waves 214) based on information about a performance of one or more sensors and/or a quality and/or noise of data captured by one or more sensors. For example, if the AV 102 detects a degradation in a performance of a sensor, a reduced quality of data from the sensors, and/or a certain amount of noise in data from the sensor, the AV 102 may determine that the sensor may have a threshold amount of debris on its surface causing such degradation in performance, reduction in quality, and/or amount of noise, and may need to be cleaned. The AV 102 can use this information to supplement the acoustic data and/or verify the acoustic data.

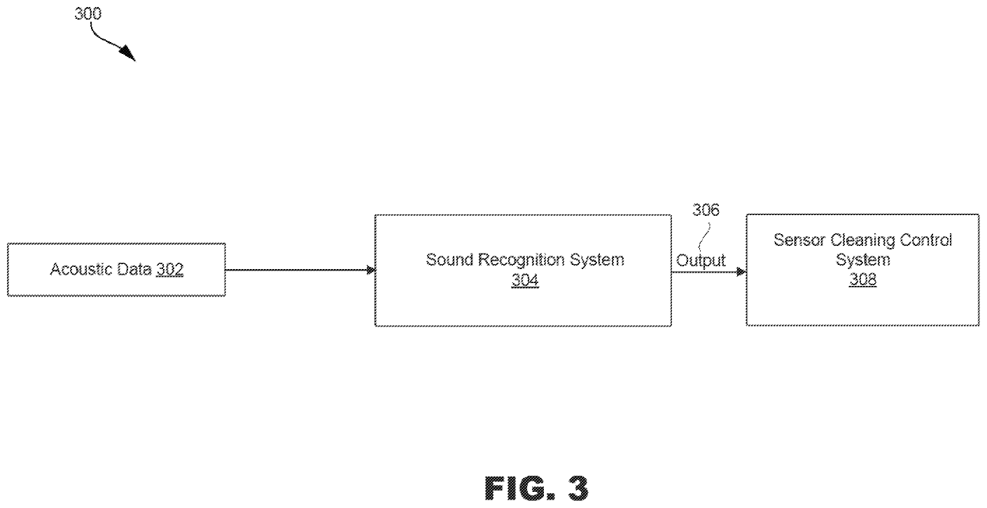

FIG. 3 is a diagram illustrating an example system 300 for recognizing acoustic signatures and/or associated sounds indicating sensor contamination and/or an environment that has debris, such as an environment that includes precipitation and/or other debris. In this example, a sound recognition system 304 can receive acoustic data 302 collected by one or more acoustic sensors (e.g., acoustic sensors 220) of an AV (e.g., AV 102) navigating in an environment. The sound recognition system 304 can recognize an acoustic signature of the acoustic data 302 and provide an output 306 to a sensor cleaning control system 308. For example, the sound recognition system 304 can recognize sound (and/or an associated acoustic signature) in the acoustic data 302 and/or associated with the acoustic data 302, and provide an output 306 to the sensor cleaning control system 308. The output 306 can include a determination that an acoustic signature of the acoustic data 302 is associated with sensor contamination (e.g., corresponds to an environment that includes debris (and/or has a threshold likelihood of including debris) and/or has a likelihood of resulting in sensor contamination).

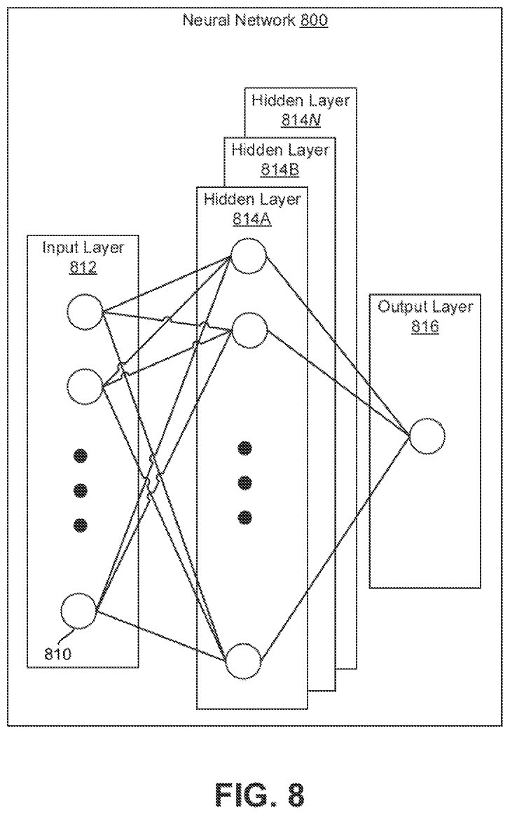

In some examples, the sound recognition system 304 can include one or more sound recognition algorithms, such as a sound matching algorithm (e.g., matching to known sounds and/or signatures of known sounds), a heuristics algorithm for recognizing and/or classifying sounds, a machine learning algorithm, and/or any other algorithms. In some cases, the sound recognition system 304 can include a machine learning and/or artificial intelligence (AI) model such as, for example, a neural network classifier model, a convolutional neural network (CNN) model, and/or any other machine learning and/or AI model. For example, in some cases, the sound recognition system 304 can include a neural network, such as neural network 800 illustrated in FIG. 8. In other cases, the sound recognition system 304 additionally or alternatively include a statistical model configured to determine whether acoustic data (e.g., an associated acoustic signature) is associated with sensor contamination.

In some cases, the sound recognition system 304 can be trained on acoustic data, such as acoustic signatures, that correspond to sensor contamination (e.g., known to include debris or a certain amount of debris that can be deposited on sensors of a vehicle, known to result in sensor contamination, etc.). The sound recognition system 304 can learn based on such data to determine whether an acoustic signature is or is not associated with sensor contamination. In some examples, the sound recognition system 304 can include a knowledge base of acoustic data (e.g., acoustic signatures) associated with sensor contamination. The sound recognition system 304 can use such knowledge base to determine whether certain acoustic data is or is not associated with sensor contamination. In some cases, the sound recognition system 304 can include a probability model that can determine whether acoustic data (e.g., an acoustic data) is associated with sensor contamination (or has a threshold probability of being associated with sensor contamination) based on statistical information associated with the acoustic data. In an illustrative example, the statistical information can be determined, programmed, and/or compared with acoustic data and/or associated probabilities corresponding to sensor contamination.

In some examples, the sound recognition system 304 can determine one or more features (e.g., one or more sounds, wavelengths, amplitudes, frequencies, time periods, velocities, sound vibrations, patterns, noise ratios, noise levels, sound lengths, audio signal segments, acoustic energy and/or energy sequence, etc.) and/or signal characteristics of the acoustic data 302, and determine an acoustic signature of the acoustic data 302 based on the one or more features and/or signal characteristics. The sound recognition system 304 can match the acoustic signature (and/or the one or more features and/or signal characteristics), with one or more acoustic signatures (and/or associated features and/or signal characteristics) of acoustic data collected in and/or corresponding to an environment that includes debris (e.g., precipitation 202, puddle 206, matter 204, etc.) and/or an environment associated with sensor contamination. For example, the sound recognition system 304 can compare the one or more features and/or signal characteristics of an acoustic signature of the acoustic data 302 with one or more features and/or signal characteristics of one or more acoustic signatures of sound waves known to correspond to (and/or collected in) environments with debris, sounds created by debris in the environment, sounds associated with environments with debris (e.g., thunder sounds, sounds of windshield wipers, splashing sounds, sounds of shovels, sounds of wet surfaces, etc.), and/or sounds created in environments with debris.

As another example, the sound recognition system 304 can compare the acoustic data 302 (and/or segments thereof) with other acoustic data (and/or segments thereof) known to correspond to environments with debris, sounds created by debris in the environment, and/or sounds created in environments with debris. In some cases, the sound recognition system 304 can determine that an acoustic signature of the acoustic data 302 or one or more features and/or, signal characteristics of an acoustic signature of the acoustic data 302 corresponds/correspond to and/or is/re indicative of sounds created by debris in the environment, environments that have certain conditions (e.g., that have debris, that have thunder, that have the sound of windshield wipers, that have the sound of wet surfaces, that have the sound of road salt, that have the sound of inclement weather vehicles, that have the sound of shovels, etc.), environments associated with sensor contamination, and/or a presence of debris in the environment.

For example, based on the acoustic signature of the acoustic data 302, the sound recognition system 304 can determine that the acoustic data 302 includes and/or corresponds to thunder, sounds of windshield wipers, sounds of snow tires or tires with chains or other traction elements, sounds of an inclement weather vehicle, sounds of road salt being deposited on the ground, sounds of shovels removing precipitation (e.g., ice, snow, slush, etc.), splashing sounds, and/or sounds of debris (e.g., precipitation, particles from a puddle, particles in the air, and/or other debris) falling on and/or colliding with a surface(s) in the environment, such as a surface on the ground, a puddle, a vehicle, the AV 102, a tree or plant, and/or a structure in the environment (e.g., a house, a roof, a bus stop shelter, etc.). To illustrate, based on the acoustic signature of the acoustic data 302 (and/or one or more segments thereof), the sound recognition system 304 can classify and/or recognize the acoustic data 302 (and/or a sound(s) associated with the acoustic data 302) as a particular sound associated with sensor contamination (e.g., associated with debris or an environment containing debris, such as a splashing sound, a thunder sound, a sound of tires on a wet surface, a sound of tires on road salt, a sound of shovels, and/or a sound of debris falling on and/or colliding with one or more surfaces in the environment).

The sound recognition system 304 can generate the output 306 based on the acoustic data 302. In some examples, the output 306 can include an indication of a presence (and/or a likelihood of a presence) of sensor contamination. In some cases, the output 306 can include an indication of a presence of certain debris in the environment (and/or a threshold amount of debris in the environment), a probability of debris being present in the environment, a likelihood that one or more sensors of the AV 102 may need cleaning (e.g., determined based on a presence of debris in the environment and/or a type of environment associated with debris), and/or an environment associated with sensor contamination. In some cases, the output 306 can include a classification output, such as an output classifying an environment being associated with sensor contamination, such as an environment containing debris (and/or a threshold amount of debris), and/or an environment configured to trigger an activation of one or more sensor cleaning systems.

The sound recognition system 304 can provide the output 306 to a sensor cleaning control system 308. The sensor cleaning control system 308 can use the output 306 to determine whether to activate one or more sensor cleaning systems on the AV 102. In some examples, the sensor cleaning control system 308 can determine whether to activate the one or more sensor cleaning systems on the AV 102 based on a classification of a sound, an acoustic signature, and/or environment associated with the acoustic data 302. In some cases, the sensor cleaning control system 308 can assign different weights to different sound, acoustic signature, and/or environment classifications. The weights can determine how much the different sound, acoustic signature, and/or environment classifications may influence a decision by the sensor cleaning control system 308 to activate one or more sensor cleaning systems (and/or certain types of sensor cleaning systems).

For example, a sound, acoustic signature, and/or environment classification having a higher confidence of a presence of debris or sensor contamination can receive a higher weight than a sound, acoustic signature, and/or environment classification with a lower confidence. As another example, a sound, acoustic signature, and/or environment classifications indicative of more debris in the environment and/or certain types of debris that may degrade a performance of sensors more than other types of debris, can receive a higher weight than sound, acoustic signature, and/or environment classifications indicative of less debris and/or the other types of debris that may degrade a performance of sensors less than certain types of debris.

In some examples, the sensor cleaning control system 308 can increase the weights associated with a sound, acoustic signature, and/or environment classification as the amount of time that the AV 102 is present in an associated environment and/or around associated sounds increases, as the amount of debris estimated for (and/or based on) an environment classification increases, as the amount of sensor contamination estimated for an environment increases, and/or as the confidence of the output 306 that there is sensor contamination or the environment of the AV 102 includes debris (and/or certain types of debris) increases. For example, if the output 306 indicates that there is sensor contamination and/or the AV 102 is in an environment with heavy rain (e.g., above a threshold amount of precipitation), the sensor cleaning control system 308 can increase the weight of a classification associated with that environment (e.g., and thus the likelihood that such environment will trigger a sensor cleaning system) as compared to the weight of an environment with lighter rain. As noted above, the classification and associated weight (if any) can be used to determine whether to activate one or more sensor cleaning systems on the AV 102.

In some cases, the sensor cleaning control system 308 can activate certain or all sensor cleaning systems of the AV 102 based on the output 306. In other cases, the sensor cleaning control system 308 can use the output 306 to determine which (if any) sensor cleaning systems to activate. For example, if the output 306 indicates that an environment includes precipitation, the sensor cleaning control system 308 can activate a sensor cleaning system configured to remove precipitation from sensors, such as a sensor cleaning system that uses compressed air to remove precipitation and/or droplets from a sensor, a cleaning system that uses blades or wipers to remove precipitation and/or droplets from a sensor, etc. If the output 306 indicates that an environment includes dirt or bugs, the sensor cleaning control system 308 can activate a sensor cleaning system configured to remove such debris, such as a sensor cleaning system that uses liquid (e.g., washing fluid or water) to clean a sensor.

In response to determining to activate one or more sensor cleaning systems, the sensor cleaning control system 308 can trigger the one or more sensor cleaning system to activate. For example, the sensor cleaning control system 308 can send a signal to one or more drivers and/or controllers of the one or more sensor cleaning systems to trigger the one or more sensor cleaning systems to activate. In some cases, the sensor cleaning control system 308 can specify a timeframe and/or number of cycles that the one or more sensor cleaning systems should run, or activate the one or more sensor cleaning systems for an undefined period (and/or until a sensor cleaning stop signal is received and/or generated).

In some cases, the sensor cleaning control system 308 can verify a sensor cleaning determination made based on the output 306 before activating one or more sensor cleaning systems (or deciding not to activate them). For example, if the sensor cleaning control system 308 determines, based on the output 306, that one or more sensor cleaning systems should be activated, the sensor cleaning control system 308 can use other data to verify that an acoustic signature is associated with sensor contamination, an environment includes debris, and/or that the sensors need cleaning. To illustrate, the sensor cleaning control system 308 can analyze data from one or more sensors to verify whether the one or more sensors should be cleaned. For example, if the one or more sensors include a camera, the sensor cleaning control system 308 can use an algorithm to determine whether image data from the camera shows debris in a surface of the camera and/or whether a quality of the image data has been negatively affected by potential debris on the surface of the camera. As another example, the sensor cleaning control system 308 can use the image data from the camera to detect debris in the environment, such as rain, snow, ice, puddles, wet surfaces, splashing, mud, etc.

In another example, the sensor cleaning control system 308 can use data from other types of sensors to verify a determination whether to activate one or more sensor cleaning systems. For example, the sensor cleaning control system 308 can use LIDAR data, RADAR data, ultrasonic data, infrared data, and/or other sensor data to verify a determination whether to activate one or more sensor cleaning systems. The sensor cleaning control system 308 can perform the verification based on a content of such data (e.g., features in the data, etc.) and/or a quality of the data (e.g., a lower quality of sensor data can indicate that an associated sensor is more likely to need cleaning, and a higher quality of sensor data can indicate that an associated sensor is less likely to need cleaning).

In some examples, the sensor cleaning control system 308 can use the output 306 as one of multiple considerations used to determine whether to activate one or more sensor cleaning systems. For example, to determine whether to activate one or more sensor cleaning systems, the sensor cleaning control system 308 can use the output 306 determined based on the acoustic data 302 as well as data from one or more other sources, such as weather data from a source such as a weather reporting service or the Internet, a humidity of the environment measured by a humidity sensor of the AV 102, a temperature of the environment 200 measured by a temperature sensor of the AV 102, characteristics of the environment 200 determined based on light transmitted and/or received by an optical sensor(s) of the AV 102, characteristics of the environment detected based on image data captured by one or more camera sensors of the AV 102, data about a performance of one or more sensors of the AV 102 and/or data captured by the one or more sensors, and/or other data.

To illustrate, the output 306 determined based on the acoustic data 302 can indicate that there may be sensor contamination (e.g., can indicate that there may be certain debris (and/or a certain amount of such debris) in the environment and/or sensors of the AV 102) and may suggest or indicate a need to clean one or more sensors of the AV 102. In addition, to determine whether the sensor cleaning control system 308 should activate one or more sensor cleaning systems of the AV 102, the sensor cleaning control system 308 may supplement the output 306 with information about a humidity of the environment determined by a humidity sensor (e.g., information indicating whether there is a threshold amount of humidity and/or precipitation in the environment) information about a temperature of the environment (e.g., which can indicate whether the temperature is below freezing, above freezing, or within a range above and below freezing), data collected by an optical sensor (e.g., a camera sensor, a LIDAR sensor, etc.) that indicates one or more characteristics of the environment (e.g., a presence and/or amount of debris in the environment) based on light transmitted and/or received by the optical sensor, image data from a camera sensor used to detect debris in a scene depicted in the image data, and/or data about a performance of one or more sensors of the AV 102 (and/or associated data).

In some examples, the sensor cleaning control system 308 can collect additional data (e.g., in addition to the output 306) that the sensor cleaning control system 308 can use, along with the output 306, to determine whether to activate one or more sensor cleaning systems of the AV 102. For example, data from an optical sensor of the AV 102 can be used to determine one or more characteristics of the environment (e.g., precipitation levels, humidity levels, ambient light levels, air quality levels, density of certain particles in the air, debris on the ground in the environment, debris in the air, one or more surface characteristics, etc.) of the AV 102 based on a light reflectivity of one or more surfaces in the environment and/or one or more characteristics of light (e.g., a frequency, an amplitude, a phase shift, a time-of-flight, an amount of reflected light, an amount of refracted light, an amount of scattered light, a signature of transmitted and/or received light, a feature of transmitted and/or received light, etc.) collected by the optical sensor (e.g., ambient light collected by the optical sensor, light reflected from one or more surfaces in the scene and received by the optical sensor, light transmitted by one or more light sources and received by the optical sensor, etc.). The one or more characteristics of the environment can be used to determine sensor contamination and/or one or more conditions of the environment associated with sensor contamination, such as whether the environment has certain types of debris (and/or a threshold amount of such debris).

The sensor cleaning control system 308 can receive (e.g., from another system) the one or more conditions of the environment, the one or more characteristics of the environment of the AV 102 used to determine the one or more conditions of the environment, or the data from the optical sensor used to determine the one or more characteristics of the environment. The sensor cleaning control system 308 can use the output 306 determined based on the acoustic data 302 and the one or more conditions of the environment to determine whether to activate one or more sensor cleaning systems of the AV 102 and/or which (if any) sensor cleaning systems of the AV 102 to activate (e.g., based on a determination of which sensors of the AV 102, if any, need to be cleaned).

In some cases, the sensor cleaning control system 308 can additionally or alternatively use the output 306 and information about a performance of one or more sensors of the AV 102 (and/or associated data) to determine whether to activate any sensor cleaning systems (and/or which to activate). For example, if a sensor has experienced a degradation of performance (e.g., a reduced field-of-view, a reduced visibility, an increased amount of noise, an increased amount of errors, an increased amount of artifacts, a decreased accuracy, a decreased resolution, a failure, a degradation in measurements, etc.) and/or the data from the sensor reflects a degradation (e.g., noise, artifacts, lower quality, lower accuracy, lower brightness levels, lower resolution, etc.), such degradation can indicate that the sensor has collected debris and may need to be cleaned. Accordingly, in addition to the output 306, the sensor cleaning control system 308 can use information about the performance of one or more sensors of the AV 102 (and/or data from the one or more sensors) to determine whether any sensors should be cleaned, whether to activate any sensor cleaning systems, and/or which (if any) sensor cleaning systems to activate.

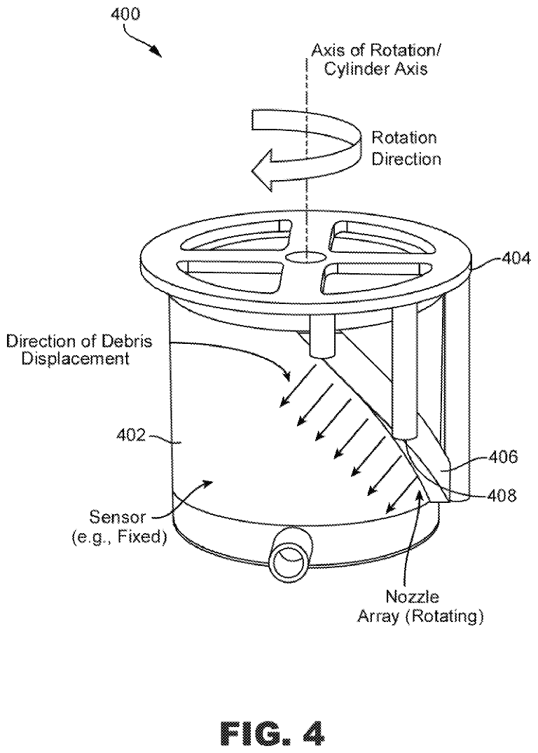

FIG. 4 is a diagram illustrating an example self-cleaning sensor system 400 for an optical sensor, according to some examples of the present disclosure. The self-cleaning sensor system 400 is used to clean an optical sensor 402 (e.g., a LiDAR sensor, camera sensor, etc.). In this example, the optical sensor 402 is a cylindrical sensor, but in other examples, the optical sensor 402 can have other shapes/dimensions. The self-cleaning sensor system 400 can be automatically activated based on acoustic signals (e.g., sound waves 214, acoustic data 302) collected by acoustic sensors (e.g., acoustic sensors 220) of a vehicle, such as AV 102. For example, the sensor cleaning control system 308 illustrated in FIG. 3 can automatically activate the self-cleaning sensor system 400 to clean the optical sensor 402 based on the output 306 of the sound recognition system 304, which is generated based on the acoustic data 302. The output 306 can include an indication that an acoustic signal of acoustic data collected in an environment is associated with sensor contamination. In some examples, the output 306 can include, for example and without limitation, an indication that the environment of the vehicle includes debris, an indication that the optical sensor 402 may be exposed to debris in the environment and/or may need cleaning, and/or a classification of the environment of the vehicle which is configured to trigger the sensor cleaning control system 308 to activate the self-cleaning sensor system 400.

In FIG. 4, the self-cleaning sensor system 400 includes a wiper housing 404 and a wiper blade 406. In some examples, the wiper blade 406 can be affixed to the wiper housing 404 such that the wiper blade 406 is positioned in a downward angle with respect to a top-surface of the optical sensor 402. The wiper blade 406 can be positioned in the downward angle to ensure that the wiper blade 406 moves any debris on the optical sensor 402 in a downward angle relative to a top-portion of the optical sensor 402 to ensure that the debris are moved away (e.g., below or to a bottom) from a surface of the optical sensor 402. However, the positioning of the wiper blade 406 in FIG. 4 is merely an illustrative example provided for explanation purposes. In other examples, the wiper blade 406 may be positioned in any other angle.

In some examples, the wiper housing 404 can be affixed to a top-surface of the optical sensor 402 so that the attachment point does not occlude an optical surface of the optical sensor 402. Although the example illustrated in FIG. 4 depicts a self-cleaning sensor system 400 with a single wiper blade (e.g., wiper blade 406), other examples may include two or more blades.

In some cases, the wiper housing 404 can be configured to rotate so that the wiper blade 406 is scanned over a surface of the optical sensor 402. Depending on the desired implementation, the wiper blade 406 can be configured to contact the surface of the optical sensor 402 or configured to rotate about the surface, without physical contact. In some examples, the optical sensor 402 may implement a light scanning operation. In such examples, the angular speed of the wiper blade 406 can be configured based on the scanning rate of the optical sensor 402 so that the wiper blade 406 does not obstruct a sensor operation. By way of example, the optical sensor 402 can include a LIDAR sensor with a particular scanning rate. As such, the wiper assembly (e.g., the wiper housing 404 and the wiper blade 406) can also rotate about the optical sensor 402 at a same or similar frequency as the LIDAR sensor. By matching the rotational frequency of the optical sensor 402 while placing the wiper blade 406 away from the path of the underlying scanning lasers (e.g., out of phase) of the optical sensor 402, sensor cleaning can be performed without interfering with the operation of the optical sensor 402.

Depending on the desired implementation, ensuring that the wiper blade 406 does not obstruct sensor operation can be performed in different ways. For example, the wiper housing 404 may be affixed to the same driver/motor that controls the laser scanning of the optical sensor 402 (e.g., the LIDAR sensor in the previous example), such that the rotational speeds of the optical sensor 402 and the wiper blade 406 (and/or the wiper assembly including the wiper housing 404 and the wiper blade 406) can be matched and/or synchronized. Alternatively, the wiper housing 404 may be controlled by a separate motor that is calibrated to match the scanning rate of the optical sensor 402. It is understood that different scanning rates for the optical sensor and/or the wiper blade 406 may be used in scanning (e.g., rotating) implementations, and the previous examples and the example illustrated in FIG. 4 are merely illustrative examples provided for explanation purposes.

In some implementations, scanning of the wiper blade 406 may not be continuous. In such approaches, the wiper blade 406, when stationary, can be positioned in an unused field of view (FOV) region of the optical sensor 402 (e.g., and/or the surface of the optical sensor 402). For example, the placement of the optical sensor 402 may be such that only a fraction of the radial view angle is used for scanning. As such, the wiper blade 406 can be parked in the unused portion of the FOV of the optical sensor 402 (e.g., the portion not used for scanning).

In some cases, removal of debris from the surface of the optical sensor 402 can be facilitated by one or more nozzles 408 on or within the wiper blade 406. In some approaches, the one or more nozzles 408 can be configured to apply (e.g., emit/output) compressed gas (e.g., air) to the surface of the optical sensor 402. In other approaches, the one or more nozzles can additionally or alternatively be configured to apply (e.g., emit/output) a liquid (e.g., water, cleaning fluid, etc.) to the surface of the optical sensor 402.

In some cases, the one or more nozzles 408 can be arranged in a helical array that points in a downward direction relative to the top surface of the optical sensor 402 so debris on the surface of the optical sensor 402 are pushed down without smearing the surface of the optical sensor 402. Moreover, by placing the one or more nozzles 408 in close proximity to (e.g., within a threshold proximity to) to the surface of the optical sensor 402 (without making contact with the surface of the optical sensor 402), the flow rate of the output (e.g., compressed gas, liquid, etc.) of the one or more nozzles 408 can be reduced as opposed to nozzles that are disposed at a greater distance. In some examples, the one or more nozzles 408 can include a fixed-array implementation. In other examples, the one or more nozzles 408 can move and/or rotate as previously described. In such examples, by rotating/scanning the one or more nozzles 408 around the surface of the optical sensor 402 via a rotation of the wiper blade 406, fewer nozzles may be implemented relative to fixed-array implementations, while still providing an effective sensor cleaning solution.

As previously noted, in some aspects, the one or more nozzles 408 can be configured to apply a liquid cleaning agent, such as water or a solvent-based cleaning fluid (e.g., ethanol or methanol, etc.), to a surface of the optical sensor 402. Additionally, in some implementations, the leading edge of the wiper blade 406 may be configured to contact the optical surface of the sensor, thereby providing mechanical force to facilitate the clearance of debris.

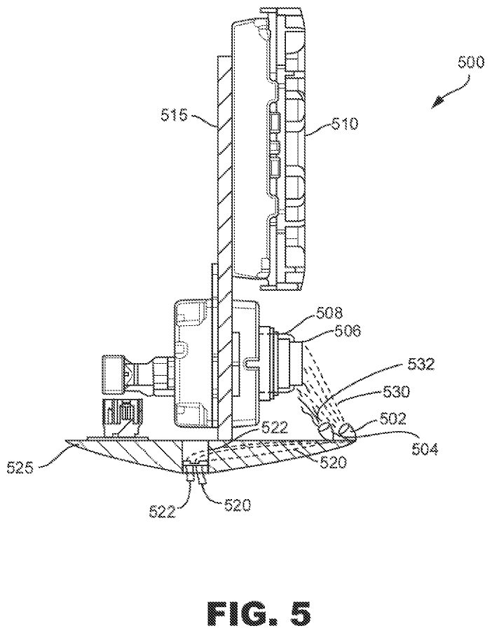

FIG. 5 is a diagram illustrating an example implementation of a cleaning system on a sensor platform 500. In this example, the cleaning system includes a liquid cleaning system 502 and an air cleaning system 504. The sensor platform 500 can include sensors 506-510 mounted on a sensor carrier structure 515. In some examples, the sensors 506-510 can include optical sensors, such as a LIDAR sensor, an optical camera sensor, and/or a thermal camera sensor. The liquid cleaning system 502 and the air cleaning system 504 can be activated based on acoustic data, as previously described. For example, the sensor cleaning control system 308 illustrated in FIG. 3 can automatically activate the liquid cleaning system 502 and/or the air cleaning system 504 to clean the sensor 506 and/or the sensor 508 based on the output 306 of the sound recognition system 304, which is generated based on the acoustic data 302. The output 306 can include an indication that an acoustic signal of acoustic data collected in an environment is associated with sensor contamination. In some cases, the output 306 can be generated based on an acoustic signature of acoustic data collected in an environment and can include, for example and without limitation, an indication that the environment of the vehicle includes debris, an indication that the sensor 506 and/or the sensor 508 may be exposed to debris in the environment and/or may need cleaning, and/or a classification of the environment of the vehicle which is configured to trigger the sensor cleaning control system 308 to activate the liquid cleaning system 502 and/or the air cleaning system 504.

The liquid cleaning system 502 and the air cleaning system 504 can be used to clean the sensor 506 and 508 on the sensor carrier structure 515. For example, the liquid cleaning system 502 can spray liquid on the surface or lens of the sensor 506 and/or the sensor 508 to clean or rinse the sensor 506 and/or the sensor 508, and the air cleaning system 504 can spray air on the lens or surface of the sensor 506 and/or the sensor 508 to remove debris from the lens or surface of the sensor 506 and/or the sensor 508 and/or to dry precipitation (e.g., liquid) on the lens or surface of the sensor 506 and/or the sensor 508. In some cases, the liquid cleaning system 502 and/or the air cleaning system 504 can also be used to clean the sensor 510. In other cases, the sensor 510 can be cleaned using another sensor cleaning system.

To carry liquid to the liquid cleaning system 502, a liquid hose 520 can be mounted to a lower cover of a base 525 of the sensor platform 500. Similarly, to carry air to the air cleaning system 504, an air hose 522 can be mounted to the lower cover of the base 525. The liquid hose 520 can be configured and aligned to carry and project liquid 530, and the air hose 522 can be configured and aligned to carry and project compressed air 532.

The liquid cleaning system 502 can receive the liquid 530 from the liquid hose 520 and output or spray the liquid 530 on and/or toward the lens or surface of the sensor 510 and/or the sensor 506 in order to clean the sensor 510 and/or the sensor 506. Similarly, the air cleaning system 504 can receive the air 532 from the air hose 522 and output or spray the air 532 on and/or toward the lens or surface of the sensor 510 and/or the sensor 506 in order to clean the sensor 510 and/or the sensor 506. The liquid cleaning system 502 and the air cleaning system 504 can each include one or more discharge elements such as one or more nozzles, vents, and/or spraying devices for controlling and enabling the flow, discharge, and/or projection of the liquid 530 and air 532 to the sensor 510 and/or the sensor 506.

While the implementation shown in FIG. 5 includes both a liquid cleaning system 502 and an air cleaning system 504, it should be noted that other implementations may include additional cleaning systems, such as additional liquid cleaning systems and/or air cleaning systems, or may only include either a liquid cleaning system 502 or an air cleaning system 504.

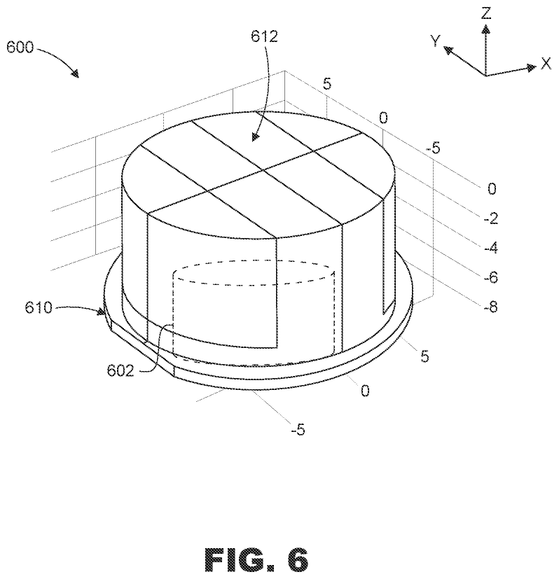

FIG. 6 is a diagram illustrating another example of a sensor cleaning system that can be implemented by a vehicle, such as AV 102. In this example, the sensor cleaning system includes an ultrasonic sensor 600 that includes self-cleaning capabilities. In some cases, the self-cleaning capabilities of the ultrasonic sensor 600 can be triggered automatically based on acoustic data. For example, the sensor cleaning control system 308 illustrated in FIG. 3 can automatically activate the self-cleaning capabilities of the ultrasonic sensor 600 to clean the ultrasonic sensor 600 based on the output 306 of the sound recognition system 304, which is generated based on the acoustic data 302. The output 306 can include, for example and without limitation, an indication that the environment of the vehicle includes debris, an indication that the ultrasonic sensor 600 may be exposed to precipitation in the environment and/or may need cleaning, and/or a classification of the environment of the vehicle which is configured to trigger the ultrasonic sensor 600 to activate its self-cleaning capabilities.

The ultrasonic sensor 600 can measure a distance to an object using ultrasonic sound waves. In some cases, the ultrasonic sensor 600 can additionally or alternatively perform other tasks such as, for example and without limitation, object detection, position detection, and/or irregularities (e.g., cracks, air bubbles, flaws, etc.) in a material. Generally, an ultrasonic sensor can be used as a transceiver to send and receive ultrasonic sound waves or pulses that relay back information about an object such as, for example, the object's proximity. For example, an ultrasonic sensor can transmit a sound wave at a certain frequency and receive an echo or return signal caused by the sound wave being reflected from a target such as an object. The ultrasonic sensor can determine the distance to the target by measuring a time lapse between the transmitted sound wave and the received ultrasonic waveform (e.g., ultrasonic echo/pulse).

As shown in FIG. 6, the ultrasonic sensor 600 can include a transducer 602 configured to send and receive sound waves, such as a piezoelectric transducer. In some examples, the transducer 602 can include a transmitter for sending sound waves and a receiver for receiving sound waves. The transmitter and receiver can be implemented as separated units or embedded within a single unit (e.g., integrated in a same unit). In FIG. 6, the transducer 602 includes a piezoelectric transmitter (e.g., also referred to as a piezoelectric actuator) and a receiver integrated into a same package or unit. For example, the transmitter component of the transducer 602 can include a piezoelectric element configured to emit sound.

The ultrasonic sensor 600 can also include a housing 610 that contains/houses the components of the ultrasonic sensor 600, such as the transducer 602. The material(s) of the housing 610 can vary in different implementations. For example, in some cases, the housing 610 can include an aluminum can or case. In other examples, the housing 610 can include a can or case of another type of metal or material.

The housing 610 can include a sensor surface 612, such as an ultrasonic radiation surface. Ultrasonic sound signals transmitted by the transducer 602 travel from the transducer 602, through the sensor surface 612, and towards a target. Ultrasonic sound signals received by the transducer 602 travel from a target, through the sensor surface 612, and back to the transducer 602.

In this example, the self-cleaning capabilities of the ultrasonic sensor 600 can include breaking and/or removing frozen precipitation, such as ice. For example, when operating the ultrasonic sensor 600 in sub-zero degree temperatures, the sensor surface 612 can accumulate frozen precipitation (e.g., ice, frost, snow, hail, etc.) that may become adhered to the sensor surface 612. The frozen precipitation on the sensor surface 612 can negatively impact the ability of the transducer 602 to send and receive signals to and from a target. For example, in some cases, the frozen precipitation on the sensor surface 612 can at least partially block sound signals transmitted by the transducer 602 and/or reflected from a target to the ultrasonic sensor 600, and/or can degrade the quality of the sound signals transmitted from the transducer 602 and/or reflected from a target towards the ultrasonic sensor 600. The ultrasonic sensor 600 can be used to remove frozen precipitation from the sensor surface 612, such as one or more layers of ice on the sensor surface 612.

In some examples, to break and remove one or more layers of frozen precipitation from the sensor surface 612, the transducer 602 can be configured to emit ultrasonic waves at a resonance frequency of the ultrasonic sensor 600 (and/or the housing 610). When the transducer 602 is driven at the resonance frequency, the shear stress created by the associated ultrasonic waves (e.g., the ultrasonic waves emitted at the resonance frequency) at the interface (e.g., the sensor surface 612) between the one or more layers of ice and/or snow and the housing 610 can exceed the adhesive shear strength of the one or more layers of ice and/or snow. As a result, the ultrasonic waves emitted by the transducer 602 at the resonance frequency can remove the one or more layers of ice and/or snow from the sensor surface 612. For example, the ultrasonic waves emitted by the transducer 602 at the resonance frequency can create a shear force that causes the one or more layers of frozen precipitation to be displaced from the sensor surface 612 and break in shear. The transducer 602 can be triggered to emit the ultrasonic waves to remove the one or more layers of ice and/or snow from the sensor surface 612 based on acoustic data collected by one or more acoustic sensors of a vehicle, as previously described.

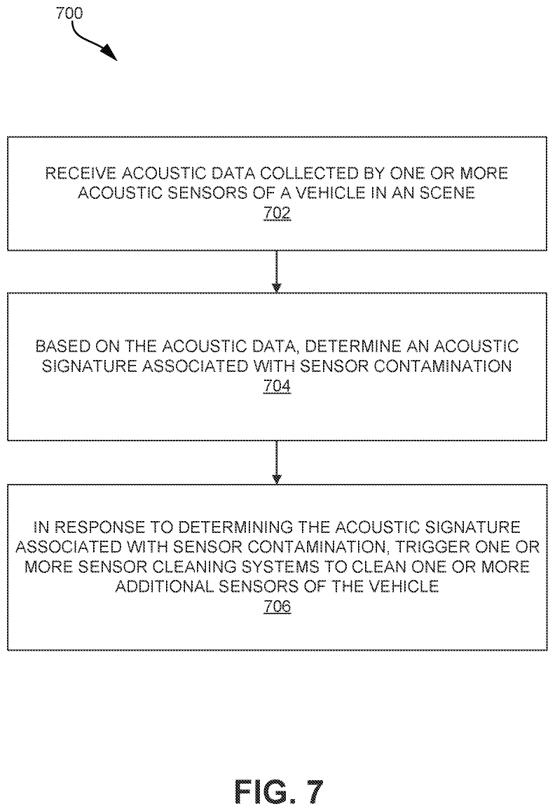

FIG. 7 is a diagram illustrating an example process 700 for automatically triggering one or more sensor cleaning systems to clean sensors of a vehicle based on acoustic data. At block 702, the process 700 can include receiving acoustic data (e.g., acoustic data 302) collected by one or more acoustic sensors (e.g., acoustic sensors 220) of a vehicle (e.g., AV 102) in an scene (e.g., environment 200). In some examples, the acoustic data can include recorded sound, a recorded soundscape, and/or recorded sound waves, and the one or more acoustic sensors can include one or more microphones.

At block 704, the process 700 can include determining, based on the acoustic data, an acoustic signature associated with sensor contamination. For example, the process 700 can include determining, based on the acoustic data, that the acoustic signature corresponds to (and/or indicates a presence of) precipitation, dirt, mud, organic matter (e.g., bugs, plant matter, etc.), and/or other debris in the environment of the scene and/or on a surface of one or more sensors of the vehicle. As another example, the process 700 can include determining that acoustic signature corresponds to (and/or indicates) a rainy environment, a snowy environment, an icy environment, a wet environment, etc., and determining the acoustic signature is associated with sensor contamination based on the determining that the acoustic signature corresponds to (and/or indicates) a rainy environment, a snowy environment, an icy environment, a wet environment, etc. In some cases, the process 700 can include determining that the acoustic signature indicates a presence of certain types of debris in the air of the environment of the scene (e.g., organic matter, precipitation, dust, etc.) and/or certain types of debris on the ground in the environment of the scene (e.g., precipitation, dust, dirt, mud, etc.). In some examples, the process 700 can include determining that the acoustic signature indicates (and/or corresponds to an environment having) at least a threshold amount of certain types of debris in the scene (e.g., in the air and/or the ground).

For example, the process 700 can include determining a frequency of detected sounds in the acoustic data and/or an acoustic signature of the acoustic data corresponds to sounds generated by certain debris or type of debris in the environment (e.g., generated via impacts of such debris with one or more surfaces in the scene such as a ground surface, a vehicle surface, an object surface, etc.) and/or sounds associated with sensor contamination. The frequency of such detected sounds can indicate the prevalence and/or amount of such debris in the environment and/or sensor contamination. For example, a higher frequency of sounds of rain drops falling on the ground and other surfaces can indicate a higher amount of rain in the scene and/or sensor contamination than a lower frequency of sounds of rain drops falling on the ground and other surfaces. As another example, a higher frequency of splashing sounds in the scene can indicate a higher amount of precipitation (e.g., rain, slush, mud, etc.) in the scene and sensor contamination than a lower frequency of splashing sounds in the scene. As yet another example, a higher frequency of sounds of particles, such as bugs, road salt, or gravel, impacting a surface in the scene, such as a surface of one or more vehicles in the scene, can indicate that there is a higher amount of such particles in the air on the scene and sensor contamination than a lower frequency of such sounds.

In some cases, the frequency of certain sounds in the acoustic data corresponding to certain debris or types of debris can be used to determine an estimated amount of debris in the scene and/or sensor contamination associated with a scene. The estimated amount of debris can include the frequency of sounds associated with the debris, or can include an estimated quantity, ratio, and/or density of such debris in the scene quantified or estimated based on the determined frequency, as previously explained. If the frequency and/or an estimated amount (e.g., quantity, ratio, and/or density estimated based on frequency) is above a threshold, the process 700 can determine that the acoustic signature is associated with sensor contamination. In some examples, if the frequency and/or an estimated amount is above a threshold, the process 700 can determine that an environment associated with the acoustic signature includes the debris or a type of debris (and/or includes sufficient debris to classify the scene as including debris and/or sensor contamination, and/or to trigger a cleaning of sensors on the vehicle), which can be used to determine that the acoustic signature is associated with sensor contamination. A determination that the acoustic signature is associated with sensor contamination can indicate that one or more sensors of the vehicle may need to be cleaned. For example, a determination that the acoustic signature is associated with sensor contamination can indicate that an environment of the scene includes certain debris (and/or a threshold amount of debris) that may be deposited or collected on one or more sensors of the vehicle, and thus may need to be removed from the one or more sensors (and/or a surface thereof).

In some cases, the process 700 can additionally or alternatively use other sensor data to determine and/or verify sensor contamination (and/or a likelihood thereof). For example, the process 700 can use other sensor data to detect a presence of debris in the scene and quantify an amount of debris in the scene in order to determine whether a threshold amount is satisfied to detect a likelihood of sensor contamination and/or trigger a cleaning of sensors on the vehicle, as further explained below. For example, image data from one or more camera sensors can be analyzed to estimate an amount of debris in the scene, such as an amount of precipitation in the air and/or the ground and/or an amount of certain particles in the air (e.g., organic matter such as bugs or plant matter, dirt, sand, road salt, etc.). The process 700 can determine if the amount of debris in the scene exceeds a threshold, and verify that the acoustic signature is associated with sensor contamination and/or trigger a cleaning of sensors if the amount of debris exceeds the threshold.

In some cases, determining the acoustic signature associated with sensor contamination includes extracting, via a machine learning model, one or more features of the acoustic data; based on the one or more features of the acoustic data, recognizing, via the machine learning model, one or more sounds reflected in the acoustic data; and determining the acoustic signature associated with sensor contamination based on the one or more features of the acoustic data.

In some examples, determining the acoustic signature associated with sensor contamination includes determining that one or more sounds reflected in the acoustic data include a sound of precipitation colliding with one or more surfaces in the scene, a sound of thunder, a sound of tires on a surface with one or more layers of precipitation, a sound of tires on a surface with road salt, a sound of windshield wipers, a splashing sound, a sound of an ice removal tool (e.g., ice pick, ice shovel), a sound of a snow shovel, and/or a sound of tires with chains for traction; and determining that the acoustic signature corresponds to sensor contamination based on the determining that one or more sounds reflected in the acoustic data include the sound of precipitation colliding with one or more surfaces in the scene, the sound of thunder, the sound of tires on the surface with one or more layers of precipitation, the sound of tires on the surface with road salt, the sound of windshield wipers, the splashing sound, the sound of an ice removal tool, the sound of a snow shovel, and/or the sound of tires with chains for traction.

In some examples, the sensor contamination can include precipitation. The precipitation can include, for example, water (e.g., rain, droplets in fog, etc.), ice, snow, and/or slush. In some cases, the one or more surfaces in the scene can include a road surface, a surface of a vehicle, a surface of a roof, and/or a surface of a structure in the scene.

In some aspects, determining the acoustic signature associated with sensor contamination can include determining one or more features associated with the acoustic data and/or one or more signal characteristics associated with the acoustic data, and determining the acoustic signature associated with sensor contamination based on the one or more features and/or the one or more signal characteristics. In some examples, determining the acoustic signature associated with sensor contamination can include comparing the acoustic signature, the one or more features, and/or the one or more signal characteristics with a predetermined acoustic signature, one or more predetermined features, and/or one or more predetermined signal characteristics associated with sensor contamination.

In some examples, the acoustic signature, the one or more features, and/or the one or more signal characteristics can include one or more sounds, one or more wavelengths of one or more sound waves, one or more amplitudes of the one or more sound waves, one or more frequencies of the one or more sound waves, one or more time periods of the one or more sound waves, one or more velocities of the one or more sound waves, one or more sound vibrations, one or more sound patterns, one or more noise ratios, one or more noise levels, one or more sound lengths, one or more audio signal segments, acoustic energy, and/or an energy sequence.

At block 706, the process 700 can include triggering, in response to determining the acoustic signature associated with sensor contamination, one or more sensor cleaning systems to clean one or more additional sensors of the vehicle. For example, the process 700 can include generating one or more signals configured to activate one or more sensor cleaning systems and/or configured to trigger an operation of the one or more sensor cleaning systems.

In some cases, the process 700 can determine which sensor cleaning systems to trigger and/or which sensors to clean with the one or more sensor cleaning systems based on a determination that the acoustic signature is associated with a certain type of sensor contamination. For example, if the sensor contamination includes precipitation, the process 700 can trigger a sensor cleaning system configured to clean a sensor(s) using a wiper blade(s) and/or compressed air. As another example, if the sensor contamination includes dirt, the process 700 can trigger a sensor cleaning system configured to clean a sensor(s) using liquid, such as water or a cleaning solution. In yet another example, if the sensor contamination includes ice, the process 700 can trigger a sensor cleaning system configured to break ice, as previously explained with respect to FIG. 6.

In some examples, the one or more additional sensors can include any sensors such as, for example, a camera sensor, a light detection and ranging (LIDAR) sensor, a radio detection and ranging (RADAR) sensor, and/or any other sensor.

FIG. 8 illustrates an example configuration of a neural network 800 that can be used to determine that an acoustic signature is associated with sensor contamination. The example configuration is merely one illustrative example provided for clarity and explanation purposes. One of ordinary skill in the art will recognize that other configurations of a neural network are also possible and contemplated herein.

In some examples, the neural network 800 can be used to implement the sound recognition system 304 or can be part of the sound recognition system 304. For example, the neural network 800 can be used to determine an acoustic signature of acoustic data collected in a scene, and determining that the acoustic signature is associated with sensor contamination (e.g., indicates sensor contamination and/or matches an acoustic signature that corresponds to sensor contamination).

In some cases, the neural network 800 can learn to detect an acoustic signature associated with sensor contamination based on training data associated with sensor contamination. For example, the neural network 800 can be trained with data including or corresponding to acoustic signatures associated with sensor contamination (e.g., indicative of sensor contamination and/or known to result in sensor contamination). To illustrate, the neural network 800 can be trained with data including or corresponding to acoustic signatures of sounds in environments with debris and/or a certain amount of debris, such as precipitation, organic matter, mud, dirt, road salt, bug matter, litter, sand, etc. The neural network 800 can then learn to recognize acoustic signatures that are associated with sensor contamination.

In FIG. 8, the neural network 800 includes an input layer 812 which includes input data. The input data can include acoustic data such as, for example, acoustic data collected by one or more acoustic sensors of a vehicle in an environment. In one illustrative example, the input layer 812 can include data representing an acoustic signature.

The neural network 800 includes hidden layers 814A through 814N (collectively “814” hereinafter). The hidden layers 814 can include n number of hidden layers, where n is an integer greater than or equal to one. The number of hidden layers can be made to include as many layers as needed for a given application. The neural network 800 further includes an output layer 816 that provides an output resulting from the processing performed by the hidden layers 814. In one illustrative example, the output layer 816 can provide a classification of an acoustic signature of an input or an indication that an acoustic signature of the input is or is not associated with sensor contamination.

The neural network 800 can include a multi-layer deep learning network of interconnected nodes. Each node can represent a piece of information. Information associated with the nodes is shared among the different layers. In some examples, each layer can retain information as information is processed. In some cases, the neural network 800 can include a feedforward network, in which case there are no feedback connections where outputs of the network are fed back into itself. For example, the neural network 800 can implement a backpropagation algorithm for training the feedforward neural network. In some cases, the neural network 800 can include a recurrent neural network, which can have loops that allow information to be carried across nodes while reading in input.

Information can be exchanged between nodes (e.g., node 810) through node-to-node interconnections between the various layers. Nodes of the input layer 812 can activate a set of nodes in the first hidden layer 814A. For example, as shown, each of the input nodes of the input layer 812 is connected to each of the nodes of the first hidden layer 814A. The nodes of the hidden layer 814A can transform the information of each input node by applying activation functions to the information. The information derived from the transformation can be passed to and can activate the nodes of the next hidden layer (e.g., 814B), which can perform their own designated functions. Example functions include convolutional, up-sampling, data transformation, pooling, filtering, and/or any other suitable functions. The output of the hidden layer (e.g., 814B) can activate nodes of the next hidden layer (e.g., 814N), and so on. The output of the last hidden layer can activate one or more nodes of the output layer 816, at which point an output is provided. In some cases, while nodes (e.g., node 810) in the neural network 800 are shown as having multiple output lines, a node has a single output and all lines shown as being output from a node represent the same output value.

In some cases, each node or interconnection between nodes can have a weight that is a set of parameters derived from training the neural network 800. For example, an interconnection between nodes can represent a piece of information learned about the interconnected nodes. The interconnection can have a numeric weight that can be tuned (e.g., based on a training dataset), allowing the neural network 800 to be adaptive to inputs and able to learn as more data is processed.

The neural network 800 can be trained to process features from the data in the input layer 812 using the different hidden layers 814 in order to provide the output through the output layer 816. In an example in which the neural network 800 is used to determine that an acoustic signature of an input is associated with sensor contamination, the neural network 800 can be trained using acoustic signatures associated with sensor contamination.

In some cases, the neural network 800 can adjust the weights of the nodes using a training process called backpropagation. Backpropagation can include a forward pass, a loss function, a backward pass, and a weight update. The forward pass, loss function, backward pass, and parameter update is performed for one training iteration. The process can be repeated for a certain number of iterations for each set of training images until the neural network 800 is trained enough so that the weights of the layers are accurately tuned.

For the example of segmenting data, the forward pass can include passing a training image through the neural network 800. The weights can be initially randomized before the neural network 800 is trained. The image can include, for example, an array of numbers representing pixels of the image. Each number in the array can include a value from 0 to 255 describing the pixel intensity at that position in the array. In one example, the array can include a 28×28×3 array of numbers with 28 rows and 28 columns of pixels and 3 color components (such as red, green, and blue, or luma and two chroma components, or the like).

For a first training iteration for the neural network 800, the output can include values that do not give preference to any particular class due to the weights being randomly selected at initialization. For example, if the output is a vector with probabilities that the object includes different classes, the probability value for each of the different classes may be equal or at least very similar (e.g., for ten possible classes, each class may have a probability value of 0.1). With the initial weights, the neural network 800 is unable to determine low level features and thus cannot make an accurate determination of what the classification of the object might be. A loss function can be used to analyze errors in the output. Any suitable loss function definition can be used.

The loss (or error) can be higher for the first training inputs since the actual values will be different than the predicted output. The goal of training is to minimize the amount of loss so that the predicted output is the same as a ground truth or training sample. The neural network 800 can perform a backward pass by determining which inputs (weights) most contributed to the loss of the network, and can adjust the weights so that the loss decreases and is eventually minimized.

A derivative of the loss with respect to the weights can be computed to determine the weights that contributed most to the loss of the network. After the derivative is computed, a weight update can be performed by updating the weights of the filters. For example, the weights can be updated so that they change in the opposite direction of the gradient. A learning rate can be set to any suitable value, with a high learning rate including larger weight updates and a lower value indicating smaller weight updates.

The neural network 800 can include any suitable deep network. For example, the neural network 800 can include a U-Net, a DCT-Network, an artificial neural network, an encoder-decoder network, an R-CNN, an FCN, and/or any other deep neural network. Another illustrative example of a neural network (e.g., neural network 800) can include a CNN. The CNN can include an input layer, one or more hidden layers, and an output layer, as previously described. The hidden layers of a CNN can include a series of convolutional, nonlinear, pooling (e.g., for down sampling), and fully connected layers. In other examples, the neural network 800 can represent any other deep network such as an autoencoder, a deep belief nets (DBNs), a Recurrent Neural Networks (RNNs), etc.

FIG. 9 illustrates an example processor-based system with which some aspects of the subject technology can be implemented. For example, processor-based system 900 can be any computing device making up local computing device 110, one or more computers of data center 150, a passenger device (e.g., client computing device 170) executing the ridehailing application 172, or any component thereof in which the components of the system are in communication with each other using connection 905. Connection 905 can be a physical connection via a bus, or a direct connection into processor 910, such as in a chipset architecture. Connection 905 can also be a virtual connection, networked connection, or logical connection.

In some examples, computing system 900 is a distributed system in which the functions described in this disclosure can be distributed within a datacenter, multiple data centers, a peer network, etc. In some examples, one or more of the described system components represents many such components each performing some or all of the function for which the component is described. In some aspects, the components can be physical or virtual devices.

Example system 900 includes at least one processing unit (CPU or processor) 910 and connection 905 that couples various system components including system memory 915, such as read-only memory (ROM) 920 and random-access memory (RAM) 925 to processor 910. Computing system 900 can include a cache of high-speed memory 912 connected directly with, in close proximity to, and/or integrated as part of processor 910.

Processor 910 can include any general-purpose processor and a hardware service or software service, such as services 932, 934, and 936 stored in storage device 930, configured to control processor 910 as well as a special-purpose processor where software instructions are incorporated into the actual processor design. Processor 910 may essentially be a completely self-contained computing system, containing multiple cores or processors, a bus, memory controller, cache, etc. A multi-core processor may be symmetric or asymmetric.

To enable user interaction, computing system 900 can include an input device 945, which can represent any number of input mechanisms, such as a microphone for speech, a touch-sensitive screen for gesture or graphical input, keyboard, mouse, motion input, speech, etc. Computing system 900 can also include output device 935, which can be one or more of a number of output mechanisms known to those of skill in the art. In some instances, multimodal systems can enable a user to provide multiple types of input/output to communicate with computing system 900. Computing system 900 can include communications interface 940, which can generally govern and manage the user input and system output. The communication interface may perform or facilitate receipt and/or transmission wired or wireless communications via wired and/or wireless transceivers, including those making use of an audio jack/plug, a microphone jack/plug, a universal serial bus (USB) port/plug, an Apple® Lightning® port/plug, an Ethernet port/plug, a fiber optic port/plug, a proprietary wired port/plug, a BLUETOOTH® wireless signal transfer, a BLUETOOTH® low energy (BLE) wireless signal transfer, an IBEACON® wireless signal transfer, a radio-frequency identification (RFID) wireless signal transfer, near-field communications (NFC) wireless signal transfer, dedicated short range communication (DSRC) wireless signal transfer, 802.11 Wi-Fi wireless signal transfer, wireless local area network (WLAN) signal transfer, Visible Light Communication (VLC), Worldwide Interoperability for Microwave Access (WiMAX), Infrared (IR) communication wireless signal transfer, Public Switched Telephone Network (PSTN) signal transfer, Integrated Services Digital Network (ISDN) signal transfer, 3G/4G/9G/LTE cellular data network wireless signal transfer, ad-hoc network signal transfer, radio wave signal transfer, microwave signal transfer, infrared signal transfer, visible light signal transfer, ultraviolet light signal transfer, wireless signal transfer along the electromagnetic spectrum, or some combination thereof.

Communications interface 940 may also include one or more Global Navigation Satellite System (GNSS) receivers or transceivers that are used to determine a location of the computing system 900 based on receipt of one or more signals from one or more satellites associated with one or more GNSS systems. GNSS systems include, but are not limited to, the US-based Global Positioning System (GPS), the Russia-based Global Navigation Satellite System (GLONASS), the China-based BeiDou Navigation Satellite System (BDS), and the Europe-based Galileo GNSS. There is no restriction on operating on any particular hardware arrangement, and therefore the basic features here may easily be substituted for improved hardware or firmware arrangements as they are developed.

Storage device 930 can be a non-volatile and/or non-transitory computer-readable memory device and can be a hard disk or other types of computer readable media which can store data that are accessible by a computer, such as magnetic cassettes, flash memory cards, solid state memory devices, digital versatile disks, cartridges, a floppy disk, a flexible disk, a hard disk, magnetic tape, a magnetic strip/stripe, any other magnetic storage medium, flash memory, memristor memory, any other solid-state memory, a compact disc read only memory (CD-ROM) optical disc, a rewritable compact disc (CD) optical disc, digital video disk (DVD) optical disc, a blu-ray disc (BDD) optical disc, a holographic optical disk, another optical medium, a secure digital (SD) card, a micro secure digital (microSD) card, a Memory Stick® card, a smartcard chip, a EMV chip, a subscriber identity module (SIM) card, a mini/micro/nano/pico SIM card, another integrated circuit (IC) chip/card, random access memory (RAM), static RAM (SRAM), dynamic RAM (DRAM), read-only memory (ROM), programmable read-only memory (PROM), erasable programmable read-only memory (EPROM), electrically erasable programmable read-only memory (EEPROM), flash EPROM (FLASHEPROM), cache memory (L1/L2/L3/L4/L9/L #), resistive random-access memory (RRAM/ReRAM), phase change memory (PCM), spin transfer torque RAM (STT-RAM), another memory chip or cartridge, and/or a combination thereof.

Storage device 930 can include software services, servers, services, etc., that when the code that defines such software is executed by the processor 910, causes the system to perform a function. In some examples, a hardware service that performs a particular function can include the software component stored in a computer-readable medium in connection with the necessary hardware components, such as processor 910, connection 905, output device 935, etc., to carry out the function.

As understood by those of skill in the art, machine-learning techniques can vary depending on the desired implementation. For example, machine-learning schemes can utilize one or more of the following, alone or in combination: hidden Markov models; recurrent neural networks; convolutional neural networks (CNNs); deep learning; Bayesian symbolic methods; general adversarial networks (GANs); support vector machines; image registration methods; applicable rule-based system. Where regression algorithms are used, they may include including but are not limited to: a Stochastic Gradient Descent Regressor, and/or a Passive Aggressive Regressor, etc.

Machine learning classification models can also be based on clustering algorithms (e.g., a Mini-batch K-means clustering algorithm), a recommendation algorithm (e.g., a Miniwise Hashing algorithm, or Euclidean Locality-Sensitive Hashing (LSH) algorithm), and/or an anomaly detection algorithm, such as a Local outlier factor. Additionally, machine-learning models can employ a dimensionality reduction approach, such as, one or more of: a Mini-batch Dictionary Learning algorithm, an Incremental Principal Component Analysis (PCA) algorithm, a Latent Dirichlet Allocation algorithm, and/or a Mini-batch K-means algorithm, etc.

Aspects within the scope of the present disclosure may also include tangible and/or non-transitory computer-readable storage media or devices for carrying or having computer-executable instructions or data structures stored thereon. Such tangible computer-readable storage devices can be any available device that can be accessed by a general purpose or special purpose computer, including the functional design of any special purpose processor as described above. By way of example, and not limitation, such tangible computer-readable devices can include RAM, ROM, EEPROM, CD-ROM or other optical disk storage, magnetic disk storage or other magnetic storage devices, or any other device which can be used to carry or store desired program code in the form of computer-executable instructions, data structures, or processor chip design. When information or instructions are provided via a network or another communications connection (either hardwired, wireless, or combination thereof) to a computer, the computer properly views the connection as a computer-readable medium. Thus, any such connection is properly termed a computer-readable medium. Combinations of the above should also be included within the scope of the computer-readable storage devices.

Computer-executable instructions include, for example, instructions and data which cause a general-purpose computer, special-purpose computer, or special-purpose processing device to perform a certain function or group of functions. By way of example, computer-executable instructions can be used to implement perception system functionality for determining when sensor cleaning operations are needed or should begin. Computer-executable instructions can also include program modules that are executed by computers in stand-alone or network environments. Generally, program modules include routines, programs, components, data structures, objects, and the functions inherent in the design of special-purpose processors, etc. that perform tasks or implement abstract data types. Computer-executable instructions, associated data structures, and program modules represent examples of the program code means for executing steps of the methods disclosed herein. The particular sequence of such executable instructions or associated data structures represents examples of corresponding acts for implementing the functions described in such steps.

Other examples of the disclosure may be practiced in network computing environments with many types of computer system configurations, including personal computers, hand-held devices, multi-processor systems, microprocessor-based or programmable consumer electronics, network PCs, minicomputers, mainframe computers, and the like. Aspects of the disclosure may also be practiced in distributed computing environments where tasks are performed by local and remote processing devices that are linked (either by hardwired links, wireless links, or by a combination thereof) through a communications network. In a distributed computing environment, program modules can be located in both local and remote memory storage devices.

The various examples described above are provided by way of illustration only and should not be construed to limit the scope of the disclosure. For example, the principles herein apply equally to optimization as well as general improvements. Various modifications and changes may be made to the principles described herein without following the example aspects and applications illustrated and described herein, and without departing from the spirit and scope of the disclosure.

Claim language or other language in the disclosure reciting “at least one of” a set and/or “one or more” of a set indicates that one member of the set or multiple members of the set (in any combination) satisfy the claim. For example, claim language reciting “at least one of A and B” or “at least one of A or B” means A, B, or A and B. In another example, claim language reciting “at least one of A, B, and C” or “at least one of A, B, or C” means A, B, C, or A and B, or A and C, or B and C, or A and B and C. The language “at least one of” a set and/or “one or more” of a set does not limit the set to the items listed in the set. For example, claim language reciting “at least one of A and B” or “at least one of A or B” can mean A, B, or A and B, and can additionally include items not listed in the set of A and B.

Illustrative examples of the disclosure include:

Aspect 1. A system comprising: at least one memory and one or more processors coupled to the at least one memory, wherein the one or more processors are configured to receive acoustic data collected by one or more acoustic sensors of a vehicle in an scene; based on the acoustic data, determine an acoustic signature associated with sensor contamination; and in response to determining the acoustic signature associated with sensor contamination, trigger one or more sensor cleaning systems to clean one or more additional sensors of the vehicle.

Aspect 2. The system of Aspect 1, wherein determining the acoustic signature associated with sensor contamination comprises: determining that one or more sounds reflected in the acoustic data include a sound of precipitation colliding with one or more surfaces in the scene, a sound of thunder, a sound of tires on a surface with one or more layers of precipitation, a sound of tires on a surface with road salt, a sound of windshield wipers, a splashing sound, a sound of an ice removal tool, a sound of a snow shovel, and/or a sound of tires with chains for traction; and determining that the acoustic signature corresponds to the sound of precipitation colliding with one or more surfaces in the scene, the sound of thunder, the sound of tires on the surface with one or more layers of precipitation, the sound of tires on the surface with road salt, the sound of windshield wipers, the splashing sound, the sound of an ice removal tool, the sound of a snow shovel, and/or the sound of tires with chains for traction.

Aspect 3. The system of Aspect 2, wherein the precipitation comprises water, ice, snow, and/or slush, and wherein the one or more surfaces in the scene comprises a road surface, a surface of a vehicle, a surface of a roof, and/or a surface of a structure in the scene.

Aspect 4. The system of any of Aspects 1 to 3, wherein determining the acoustic signature associated with sensor contamination comprises: determining one or more features associated with the acoustic data and/or one or more signal characteristics associated with the acoustic data; and determining the acoustic signature associated with sensor contamination based on the one or more features and/or the one or more signal characteristics.

Aspect 5. The system of Aspect 4, wherein the acoustic signature, the one or more features, and/or the one or more signal characteristics comprises one or more sounds, one or more wavelengths of one or more sound waves, one or more amplitudes of the one or more sound waves, one or more frequencies of the one or more sound waves, one or more time periods of the one or more sound waves, one or more velocities of the one or more sound waves, one or more sound vibrations, one or more sound patterns, one or more noise ratios, one or more noise levels, one or more sound lengths, one or more audio signal segments, acoustic energy, and/or an energy sequence.

Aspect 6. The system of any of Aspects 4 or 5, wherein determining the acoustic signature associated with sensor contamination comprises comparing the acoustic signature, the one or more features, and/or the one or more signal characteristics with a predetermined acoustic signature, one or more predetermined features, and/or one or more predetermined signal characteristics associated with sensor contamination.

Aspect 7. The system of any of Aspects 1 to 6, wherein determining the acoustic signature associated with sensor contamination comprises extracting, via a machine learning model, one or more features of the acoustic data; based on the one or more features of the acoustic data, recognizing, via the machine learning model, one or more sounds reflected in the acoustic data; and determining the acoustic signature associated with sensor contamination based on the one or more sounds recognized based on the one or more features of the acoustic data.

Aspect 8. The system of any of Aspects 1 to 7, wherein the acoustic data comprises recorded sound, a recorded soundscape, and/or recorded sound waves.

Aspect 9. The system of any of Aspects 1 to 8, wherein the one or more acoustic sensors comprises one or more microphones.

Aspect 10. The system of any of Aspects 1 to 9, wherein the one or more additional sensors comprise a camera sensor, a light detection and ranging (LIDAR) sensor, and/or a radio detection and ranging (RADAR) sensor.

Aspect 11. A method comprising: receiving acoustic data collected by one or more acoustic sensors of a vehicle in a scene; based on the acoustic data, determining an acoustic signature associated with sensor contamination; and in response to determining the acoustic signature associated with sensor contamination, triggering one or more sensor cleaning systems to clean one or more additional sensors of the vehicle.

Aspect 12. The method of Aspect 11, wherein the sensor contamination comprises precipitation.

Aspect 13. The method of Aspect 12, wherein the precipitation comprises water, ice, snow, and/or slush.

Aspect 14. The method of any of Aspects 11 to 13, wherein determining the acoustic signature associated with sensor contamination comprises: determining that one or more sounds reflected in the acoustic data include a sound of precipitation colliding with one or more surfaces in the scene, a sound of thunder, a sound of tires on a surface with one or more layers of precipitation, a sound of tires on a surface with road salt, a sound of windshield wipers, a splashing sound, a sound of an ice removal tool, a sound of a snow shovel, and/or a sound of tires with chains for traction; and determining that the acoustic signature corresponds to the sound of precipitation colliding with one or more surfaces in the scene, the sound of thunder, the sound of tires on the surface with one or more layers of precipitation, the sound of tires on the surface with road salt, the sound of windshield wipers, the splashing sound, the sound of an ice removal tool, the sound of a snow shovel, and/or the sound of tires with chains for traction.

Aspect 15. The method of Aspect 14, wherein the one or more surfaces in the scene comprises a road surface, a surface of a vehicle, a surface of a roof, and/or a surface of a structure in the scene.

Aspect 16. The method of any of Aspects 11 to 15, wherein determining the acoustic signature associated with sensor contamination comprises: determining one or more features associated with the acoustic data and/or one or more signal characteristics associated with the acoustic data; and determining the acoustic signature associated with sensor contamination based on the one or more features and/or the one or more signal characteristics.

Aspect 17. The method of Aspect 16, wherein the acoustic signature, the one or more features, and/or the one or more signal characteristics comprises one or more sounds, one or more wavelengths of one or more sound waves, one or more amplitudes of the one or more sound waves, one or more frequencies of the one or more sound waves, one or more time periods of the one or more sound waves, one or more velocities of the one or more sound waves, one or more sound vibrations, one or more sound patterns, one or more noise ratios, one or more noise levels, one or more sound lengths, one or more audio signal segments, acoustic energy, and/or an energy sequence.

Aspect 18. The method of any of Aspects 16 or 17, wherein determining the acoustic signature associated with sensor contamination comprises comparing the acoustic signature, the one or more features, and/or the one or more signal characteristics with a predetermined acoustic signature, one or more predetermined features, and/or one or more predetermined signal characteristics associated with sensor contamination.

Aspect 19. The method of any of Aspects 11 to 18, wherein determining the acoustic signature associated with sensor contamination comprises extracting, via a machine learning model, one or more features of the acoustic data; based on the one or more features of the acoustic data, recognizing, via the machine learning model, one or more sounds reflected in the acoustic data; and determining the acoustic signature associated with sensor contamination based on the one or more sounds recognized based on the one or more features of the acoustic data.

Aspect 20. The method of any of Aspects 11 to 19, wherein the acoustic data comprises recorded sound, a recorded soundscape, and/or recorded sound waves.

Aspect 21. The method of any of Aspects 11 to 20, wherein the one or more acoustic sensors comprises one or more microphones.

Aspect 22. The method of any of Aspects 11 to 21, wherein the one or more additional sensors comprise a camera sensor, a light detection and ranging (LIDAR) sensor, and/or a radio detection and ranging (RADAR) sensor.

Aspect 23. The method of any of Aspects 11 to 22, wherein the sensor contamination comprises dirt, mud, organic matter, sand, road salt, rock particles, and/or dust.

Aspect 24. A non-transitory computer-readable medium having stored thereon instructions which, when executed by one or more processors, cause the one or more processors to perform a method according to any of Aspects 11 to 23.

Aspect 25. A computer-program product having stored thereon instructions which, when executed by one or more processors, cause the one or more processors to perform a method according to any of Aspects 11 to 23.

Aspect 26. A system comprising means for performing a method according to any of Aspects 11 to 23.

Aspect 27. An autonomous vehicle comprising a computing device configured to perform a method according to any of Aspects 11 to 23, wherein the autonomous vehicle comprises the vehicle in the scene.

Aspect 28. An autonomous vehicle comprising means for performing a method according to any of Aspects 11 to 23, wherein the autonomous vehicle comprises the vehicle in the scene.

What is claimed is:

1. A system comprising:
at least one memory; and
one or more processors coupled to the at least one memory, wherein the one or more processors are configured to:
receive acoustic data collected by one or more acoustic sensors of a vehicle in an scene;
based on the acoustic data, determine an acoustic signature associated with sensor contamination; and
in response to determining the acoustic signature associated with sensor contamination, trigger one or more sensor cleaning systems to clean one or more additional sensors of the vehicle.

2. The system of claim 1, wherein determining the acoustic signature associated with sensor contamination comprises:
determining that one or more sounds reflected in the acoustic data include at least one of a sound of precipitation colliding with one or more surfaces in the scene, a sound of thunder, a sound of tires on a surface with one or more layers of precipitation, a sound of tires on a surface with road salt, a sound of windshield wipers, a splashing sound, a sound of an ice removal tool, a sound of a snow shovel, and a sound of tires with chains for traction; and
determining that the acoustic signature corresponds to at least one of the sound of precipitation colliding with one or more surfaces in the scene, the sound of thunder, the sound of tires on the surface with one or more layers of precipitation, the sound of tires on the surface with road salt, the sound of windshield wipers, the splashing sound, the sound of an ice removal tool, the sound of a snow shovel, and the sound of tires with chains for traction.

3. The system of claim 2, wherein the precipitation comprises at least one of water, ice, snow, and slush, and wherein the one or more surfaces in the scene comprises at least one of a road surface, a surface of a vehicle, a surface of a roof, and a surface of a structure in the scene.

4. The system of claim 1, wherein determining the acoustic signature associated with sensor contamination comprises:
determining at least one of one or more features associated with the acoustic data and one or more signal characteristics associated with the acoustic data; and
determining the acoustic signature associated with sensor contamination based on at least one of the one or more features and the one or more signal characteristics.

5. The system of claim 4, wherein at least one of the one or more features and the one or more signal characteristics comprises at least one of one or more sounds, one or more wavelengths of one or more sound waves, one or more amplitudes of the one or more sound waves, one or more frequencies of the one or more sound waves, one or more time periods of the one or more sound waves, one or more velocities of the one or more sound waves, one or more sound vibrations, one or more sound patterns, one or more noise ratios, one or more noise levels, one or more sound lengths, one or more audio signal segments, acoustic energy, and an energy sequence.

6. The system of claim 4, wherein determining the acoustic signature associated with sensor contamination comprises comparing at least one of the acoustic signature, the one or more features, and the one or more signal characteristics with at least one of a predetermined acoustic signature, one or more predetermined features, and one or more predetermined signal characteristics associated with sensor contamination.

7. The system of claim 1, wherein determining the acoustic signature associated with sensor contamination comprises:
extracting, via a machine learning model, one or more features of the acoustic data;
based on the one or more features of the acoustic data, recognizing, via the machine learning model, one or more sounds reflected in the acoustic data; and
determining the acoustic signature associated with sensor contamination based on the one or more sounds recognized based on the one or more features of the acoustic data.

8. The system of claim 1, wherein the acoustic data comprises at least one of recorded sound, a recorded soundscape, and recorded sound waves, wherein the one or more acoustic sensors comprises one or more microphones, and wherein the one or more additional sensors comprise at least one of a camera sensor, a light detection and ranging (LIDAR) sensor, and a radio detection and ranging (RADAR) sensor.

9. A method comprising:
receiving acoustic data collected by one or more acoustic sensors of a vehicle in an scene;
based on the acoustic data, determining an acoustic signature associated with sensor contamination; and
in response to determining the acoustic signature associated with sensor contamination, triggering one or more sensor cleaning systems to clean one or more additional sensors of the vehicle.

10. The method of claim 9, wherein determining the acoustic signature associated with sensor contamination comprises:
determining that one or more sounds reflected in the acoustic data include at least one of a sound of precipitation colliding with one or more surfaces in the scene, a sound of thunder, a sound of tires on a surface with one or more layers of precipitation, a sound of tires on a surface with road salt, a sound of windshield wipers, a splashing sound, a sound of an ice removal tool, a sound of a snow shovel, and a sound of tires with chains for traction; and
determining that the acoustic signature corresponds to at least one of the sound of precipitation colliding with one or more surfaces in the scene, the sound of thunder, the sound of tires on the surface with one or more layers of precipitation, the sound of tires on the surface with road salt, the sound of windshield wipers, the splashing sound, the sound of an ice removal tool, the sound of a snow shovel, and the sound of tires with chains for traction.

11. The method of claim 10, wherein the precipitation comprises at least one of water, ice, snow, and slush, and wherein the one or more surfaces in the scene comprises at least one of a road surface, a surface of a vehicle, a surface of a roof, and a surface of a structure in the scene.

12. The method of claim 9, wherein determining the acoustic signature associated with sensor contamination comprises:
determining at least one of one or more features associated with the acoustic data and one or more signal characteristics associated with the acoustic data; and
determining the acoustic signature associated with sensor contamination based on at least one of the one or more features and the one or more signal characteristics.

13. The method of claim 12, wherein at least one of the one or more features and the one or more signal characteristics comprises at least one of one or more sounds, one or more wavelengths of one or more sound waves, one or more amplitudes of the one or more sound waves, one or more frequencies of the one or more sound waves, one or more time periods of the one or more sound waves, one or more velocities of the one or more sound waves, one or more sound vibrations, one or more sound patterns, one or more noise ratios, one or more noise levels, one or more sound lengths, one or more audio signal segments, acoustic energy, and an energy sequence.

14. The method of claim 12, wherein determining the acoustic signature associated with sensor contamination comprises comparing at least one of the acoustic signature, the one or more features, and the one or more signal characteristics with at least one of a predetermined acoustic signature, one or more predetermined features, and one or more predetermined signal characteristics associated with sensor contamination.

15. The method of claim 9, wherein determining the acoustic signature associated with sensor contamination comprises:
extracting, via a machine learning model, one or more features of the acoustic data;
based on the one or more features of the acoustic data, recognizing, via the machine learning model, one or more sounds reflected in the acoustic data; and
determining the acoustic signature associated with sensor contamination based on the one or more sounds recognized based on the one or more features of the acoustic data.

16. The method of claim 9, wherein the acoustic data comprises at least one of recorded sound, a recorded soundscape, and recorded sound waves, wherein the one or more acoustic sensors comprises one or more microphones, and wherein the one or more additional sensors comprise at least one of a camera sensor, a light detection and ranging (LIDAR) sensor, and a radio detection and ranging (RADAR) sensor.

17. A non-transitory computer-readable medium having stored thereon instructions which, when executed by one or more processors, cause the one or more processors to:
receive acoustic data collected by one or more acoustic sensors of a vehicle in a scene;
based on the acoustic data, determine an acoustic signature associated with sensor contamination; and
in response to determining the acoustic signature associated with sensor contamination, trigger one or more sensor cleaning systems to clean one or more additional sensors of the vehicle.

18. The non-transitory computer-readable medium of claim 17, wherein determining the acoustic signature associated with sensor contamination comprises:
determining that one or more sounds reflected in the acoustic data include at least one of a sound of precipitation colliding with one or more surfaces in the scene, a sound of thunder, a sound of tires on a surface with one or more layers of precipitation, a sound of tires on a surface with road salt, a sound of windshield wipers, a splashing sound, a sound of an ice removal tool, a sound of a snow shovel, and a sound of tires with chains for traction; and
determining that the acoustic signature corresponds to at least one of the sound of precipitation colliding with one or more surfaces in the scene, the sound of thunder, the sound of tires on the surface with one or more layers of precipitation, the sound of tires on the surface with road salt, the sound of windshield wipers, the splashing sound, the sound of an ice removal tool, the sound of a snow shovel, and the sound of tires with chains for traction.

19. The non-transitory computer-readable medium of claim 17, wherein determining the acoustic signature associated with sensor contamination comprises:
determining at least one of one or more features associated with the acoustic data and one or more signal characteristics associated with the acoustic data; and
determining the acoustic signature associated with sensor contamination based on at least one of the one or more features and the one or more signal characteristics.

20. The non-transitory computer-readable medium of claim 19, wherein at least one of the acoustic signature, the one or more features, and the one or more signal characteristics comprises at least one of one or more sounds, one or more wavelengths of one or more sound waves, one or more amplitudes of the one or more sound waves, one or more frequencies of the one or more sound waves, one or more time periods of the one or more sound waves, one or more velocities of the one or more sound waves, one or more sound vibrations, one or more sound patterns, one or more noise ratios, one or more noise levels, one or more sound lengths, one or more audio signal segments, acoustic energy, and an energy sequence.
